(19) United States
(12) Patent Application Publication
(10) Pub. No.: US 2026/0352799 A1
(43) Pub. Date: Nov. 5, 2026

(54) Method and Apparatus for Chroma Channel Coding Using Multiple Reference Lines

(71) Applicants: Hyundai Motor Company, Seoul (KR); Kia Corporation, Seoul (KR); Research & Business Foundation Sungkyunkwan University, Suwon (KR)

(72) Inventors: Byeung Woo JEON, Seongnam, Gyeonggi-do (KR); Jee Yoon PARK, Seoul (KR); Yu Jin LEE, Suwon, Gyeonggi-do (KR); Jin HEO, Seoul (KR); Seung Wook PARK, Seoul (KR)

(21) Appl. No.: 18/775,673

(22) Filed: Jul. 17, 2024

Related U.S. Application Data
(63) Continuation of application No. PCT/KR2023/000359, filed on Jan. 9, 2023.

(30) Foreign Application Priority Data
Jan. 19, 2022 (KR) 10-2022-0008047
May 30, 2022 (KR) 10-2022-0065924
Jan. 6, 2023 (KR) 10-2023-0002155

(51) Int. Cl. H04N 19/105; H04N 19/11; H04N 19/174; H04N 19/176; H04N 19/186; H04N 19/70

(52) U.S. Cl. CPC H04N 19/105; H04N 19/11; H04N 19/174; H04N 19/176; H04N 19/186; H04N 19/70

(57) ABSTRACT

A method and an apparatus for video coding utilize a chroma channel prediction based on multiple reference lines. The video coding method and the apparatus generate a predictor of a chroma channel by using multiple reference lines when the current block is intra-predicted based on an intra-prediction mode or a cross-component linear model (CCLM).

### CROSS-REFERENCE TO RELATED APPLICATIONS

This application is a continuation of International Application No. PCT/KR2023/000359 on January 9, which claims under 35 U.S.C. § 119 (a) the benefit of Korean Patent Application No. 10-2022-0008047 filed on Jan. 19, 2022, Korean Patent Application No. 10-2022-0065924 filed on May 30, 2022, and Korean Patent Application No. 10-2023-0002155, filed on Jan. 6, 2023, the entire contents of each of which are incorporated herein by reference.

### BACKGROUND

### (a) Technical Field

The present disclosure relates to a video coding method and an apparatus using a chroma channel prediction based on multiple reference lines.

### (b) Description of the Related Art

Since video data has a large size compared to audio or still image data, the video data requires a lot of hardware resources, including memory, to store or transmit the video data without processing for compression.

Accordingly, an encoder is generally used to compress and store or transmit video data. A decoder receives the compressed video data, decompresses the received compressed video data, and plays the decompressed video data. Video compression techniques include H.264/AVC, High Efficiency Video Coding (HEVC), and Versatile Video Coding (VVC), which has improved coding efficiency by about 30% or more compared to HEVC.

However, since the image size, resolution, and frame rate gradually increase, the amount of data to be encoded also increases. Accordingly, a new compression technique providing higher coding efficiency and an improved image enhancement effect than existing compression techniques is required.

Intra prediction predicts pixel values of the current block to be encoded by utilizing pixel information within the common picture. In accord with the features of video, intra prediction may select and use the optimal one of many intra-prediction modes (IPMs) to predict the current block. The encoder selects one of the many intra-prediction modes and uses the selected mode to encode the current block. The encoder may then pass information on that mode to the decoder.

The HEVC technology utilizes a total of 35 intra-prediction modes for intra prediction, including 33 directional or angular modes and 2 non-directional or non-angular modes. However, as the spatial resolution of the video increases from 720×480 to 2048×1024 or 8192×4096, the unit size of the prediction block is increasing in proportion, which in turn increases the need to add more intra-prediction modes. The VVC technology, using 65 subdivided prediction modes for intra prediction, can utilize more prediction directions than in the prior art.

In general, an image to be encoded is partitioned into coding units (CUs) of various shapes and sizes, and the image is encoded by CUs. The information specifying the partitioning is represented in a tree structure, which is passed to the decoder, which prescribes how the image is partitioned into CUs of certain shapes and sizes. The luma and chroma components may be partitioned into CUs separately. Alternatively, both luma and chroma components may be partitioned into CUs of the same shape. The technique providing the luma block and chroma block with different partition structures is called the Chroma Separate Tree (CST) technique or dual tree technique. With the CST technique used, the chroma block is partitioned separately from the luma block, and information on each partition structure is signaled to the decoder. Additionally, a technique providing the luma block and chroma block with the same partition structure is called the single tree technique. With the single tree technique used, the chroma block and the luma block have the same, i.e., a common partition structure, information of which is signaled to the decoder.

A linear relationship may exist between the pixels in the chroma channel and the corresponding pixels in the luma channel. By utilizing this linear relationship to generate a predictor of the chroma channel from the pixels of the luma channel, more effective encoding can be achieved. This prior art technique is known as the cross-component linear model (CCLM) technique. For the intra prediction of the current chroma block, the CCLM technique determines the luma channel's internal region that corresponds to the current chroma block. The CCLM technique then derives a linear relation by using the pixels on the neighboring reference line of the current chroma block and the corresponding luma pixels. The CCLM technique uses the derived linear relation to generate a predictor of the current chroma block from the pixels in the corresponding luma region. Depending on the chroma channel subsampling (e.g., 4:4:4, 4:2:2, 4:2:0), if the size of the corresponding luma region is different from that of the current chroma block, downsampling may be performed on the corresponding luma region to equalize the size of the corresponding luma region to that of the current chroma block.

Meanwhile, in intra prediction, the performance of the intra prediction technique is related to the proper selection of reference pixels, since the predictor is generated based on the neighboring pixels of the current block. In this regard, besides obtaining reference pixels with a more accurate angular direction by diversifying the prediction modes as described above, increasing the number of available candidate reference pixels may be considered. Prior art techniques for increasing the available candidate reference pixels include Multiple Reference Line (MRL) or Multiple Reference Line Prediction (MRLP). The MRL technique not only uses reference lines neighboring the current block for prediction of the current block but can also use pixels further away as reference pixels. However, a deal-breaker with intra prediction of chroma blocks based on intra-prediction mode or CCLM is its exclusive use of a single reference line. Therefore, methods need to be provided for efficiently utilizing reference lines when intra-predicting chroma blocks to increase video coding efficiency and enhance video quality.

### SUMMARY

The present disclosure provides a video coding method and an apparatus for generating a predictor of a chroma channel by using multiple reference lines when the current block is intra-predicted based on an intra-prediction mode (IPM) or a cross-component linear model (CCLM).

At least one aspect of the present disclosure provides a method performed by a video decoding device for intra-predicting a current chroma block. The method includes decoding from a bitstream a chroma intra-prediction mode of the current chroma block. The method also includes determining, based on multiple neighboring chroma pixel lines of the current chroma block or multiple neighboring luma pixel lines of a representative luma block, a reference line of one of the multiple neighboring chroma pixel lines that corresponds to the current chroma block to provide a determined reference line. Here, the representative luma block comprises luma pixels corresponding to pixels at preset positions of the current chroma block and the current chroma block uses a reference line that is indicated by a reference line index of the current chroma block. The method also includes generating a predictor of the current chroma block by using the determined reference line according to the chroma intra-prediction mode.

Another aspect of the present disclosure provides a method performed by a video encoding device for intra-predicting a current chroma block. The method includes determining a chroma intra-prediction mode of the current chroma block. The method also includes determining, based on multiple neighboring chroma pixel lines of the current chroma block or multiple neighboring luma pixel lines of a representative luma block, a reference line of one of the multiple neighboring chroma pixel lines that corresponds to the current chroma block to provide a determined reference line. Here, the representative luma block comprises luma pixels corresponding to pixels at preset positions of the current chroma block and the current chroma block uses a reference line that is indicated by a reference line index of the current chroma block. The method also includes generating a predictor of the current chroma block by using the determined reference line according to the chroma intra-prediction mode.

Yet another aspect of the present disclosure provides a computer-readable recording medium storing a bitstream generated by a video encoding method. The video encoding method includes determining a chroma intra-prediction mode of a current chroma block. The video encoding method also includes determining, based on multiple neighboring chroma pixel lines of the current chroma block or multiple neighboring luma pixel lines of a representative luma block, a reference line of one of the multiple neighboring chroma pixel lines that corresponds to the current chroma block to provide a determined reference line. Here, the representative luma block comprises luma pixels corresponding to pixels at preset positions of the current chroma block and the current chroma block uses a reference line that is indicated by a reference line index of the current chroma block. The video encoding method also includes generating a predictor of the current chroma block by using the determined reference line according to the chroma intra-prediction mode.

As described above, the present disclosure provides a video coding method and an apparatus for generating a predictor of a chroma channel by using multiple reference lines when the current block is intra-predicted based on an intra-prediction mode or a cross-component linear model (CCLM). Thus, the video coding method and the apparatus improve video quality and increase video coding efficiency.

### BRIEF DESCRIPTION OF THE DRAWINGS

FIG. 1 is a block diagram of a video encoding apparatus that may implement the techniques of the present disclosure.

FIG. 2 illustrates a method for partitioning a block using a quadtree plus binary tree ternary tree (QTBTTT) structure.

FIGS. 3A and 3B illustrate a plurality of intra prediction modes including wide-angle intra prediction modes.

FIG. 4 illustrates neighboring blocks of a current block.

FIG. 5 is a block diagram of a video decoding apparatus that may implement the techniques of the present disclosure.

FIG. 6A through 6C are diagrams illustrating neighboring reference pixels used in each of cross-component linear model (CCLM) modes.

FIG. 7 is a diagram illustrating downsampling filters according to color formats.

FIG. 8 is a diagram illustrating reference lines of an multiple reference line (MRL) technique, according to at least one embodiment of the present disclosure.

FIG. 9 is a diagram illustrating reference lines of a chroma block, according to at least one embodiment of the present disclosure.

FIG. 10 is a diagram illustrating pixels at specific locations in a current chroma block, according to at least one embodiment of the present disclosure.

FIG. 11 is a diagram illustrating a representative luma block according to at least one embodiment of the present disclosure.

FIG. 12 is a diagram illustrating a common location of the current chroma block and the representative luma block.

FIG. 13 is a diagram illustrating CCLM reference pixels according to at least one embodiment of the present disclosure.

FIG. 14 is a diagram illustrating CCLM reference pixels according to another embodiment of the present disclosure.

FIG. 15 is a diagram illustrating a reference line index based on the center of a downsampling filter.

FIG. 16 is a diagram illustrating locations of CCLM reference pixels of a chroma block, according to at least one embodiment of the present disclosure.

FIG. 17 is a diagram illustrating CCLM reference pixels of a corresponding luma region, according to at least one embodiment of the present disclosure.

FIG. 18 is a diagram further illustrating downsampling filters according to color formats.

FIG. 19 is a diagram illustrating a downsampling filter utilized in a 4:2:0 format.

FIG. 20 is a flowchart of a method performed by a video encoding device for encoding a current chroma block, according to at least one embodiment of the present disclosure.

FIG. 21 is a flowchart of a method performed by a video decoding device for decoding the current chroma block, according to at least one embodiment of the present disclosure.

FIG. 22 is a flowchart of a method performed by the video encoding device for encoding the current chroma block, according to another embodiment of the present disclosure.

FIG. 23 is a flowchart of a method performed by the video decoding device for decoding the current chroma block, according to another embodiment of the present disclosure.

### DETAILED DESCRIPTION

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Hereinafter, some embodiments of the present disclosure are described in detail with reference to the accompanying illustrative drawings. In the following description, like reference numerals designate like elements, although the elements are shown in different drawings. Further, in the following description of some embodiments, detailed descriptions of related known components and functions when considered to obscure the subject of the present disclosure may be omitted for the purpose of clarity and for brevity.

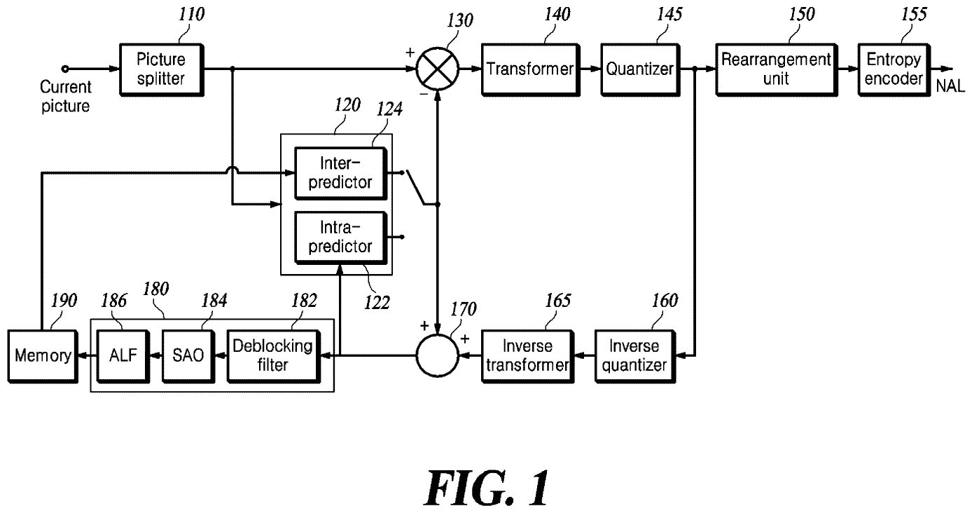

FIG. 1 is a block diagram of a video encoding apparatus that may implement technologies of the present disclosure. Hereinafter, referring to illustration of FIG. 1, the video encoding apparatus and components of the apparatus are described.

The encoding apparatus may include a picture splitter 110, a predictor 120, a subtractor 130, a transformer 140, a quantizer 145, a rearrangement unit 150, an entropy encoder 155, an inverse quantizer 160, an inverse transformer 165, an adder 170, a loop filter unit 180, and a memory 190.

Each component of the encoding apparatus may be implemented as hardware or software or implemented as a combination of hardware and software. Further, a function of each component may be implemented as software, and a microprocessor may also be implemented to execute the function of the software corresponding to each component.

One video is constituted by one or more sequences including a plurality of pictures. Each picture is split into a plurality of areas, and encoding is performed for each area. For example, one picture is split into one or more tiles or/and slices. Here, one or more tiles may be defined as a tile group. Each tile or/and slice is split into one or more coding tree units (CTUs). In addition, each CTU is split into one or more coding units (CUs) by a tree structure. Information applied to each coding unit (CU) is encoded as a syntax of the CU, and information commonly applied to the CUS included in one CTU is encoded as the syntax of the CTU. Further, information commonly applied to all blocks in one slice is encoded as the syntax of a slice header, and information applied to all blocks constituting one or more pictures is encoded to a picture parameter set (PPS) or a picture header. Furthermore, information, which the plurality of pictures commonly refers to, is encoded to a sequence parameter set (SPS). In addition, information, which one or more SPS commonly refer to, is encoded to a video parameter set (VPS). Further, information commonly applied to one tile or tile group may also be encoded as the syntax of a tile or tile group header. The syntaxes included in the SPS, the PPS, the slice header, the tile, or the tile group header may be referred to as a high level syntax.

The picture splitter 110 determines a size of a coding tree unit (CTU). Information on the size of the CTU (CTU size) is encoded as the syntax of the SPS or the PPS and delivered to a video decoding apparatus.

The picture splitter 110 splits each picture constituting the video into a plurality of coding tree units (CTUs) having a predetermined size and then recursively splits the CTU by using a tree structure. A leaf node in the tree structure becomes the coding unit (CU), which is a basic unit of encoding.

The tree structure may be a quadtree (QT) in which a higher node (or a parent node) is split into four lower nodes (or child nodes) having the same size. The tree structure may also be a binary tree (BT) in which the higher node is split into two lower nodes. The tree structure may also be a ternary tree (TT) in which the higher node is split into three lower nodes at a ratio of 1:2:1. The tree structure may also be a structure in which two or more structures among the QT structure, the BT structure, and the TT structure are mixed. For example, a quadtree plus binary tree (QTBT) structure may be used or a quadtree plus binary tree ternary tree (QTBTTT) structure may be used. Here, a binary tree ternary tree (BTTT) is added to the tree structures to be referred to as a multiple-type tree (MTT).

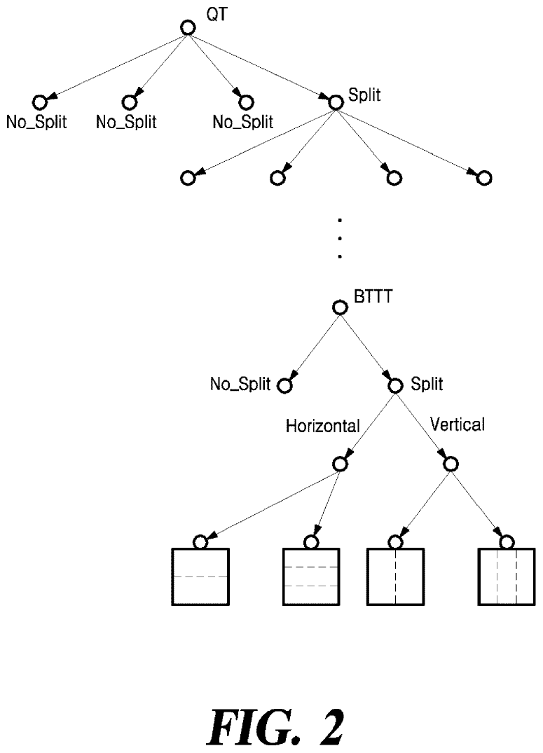

FIG. 2 is a diagram for describing a method for splitting a block by using a QTBTTT structure.

As illustrated in FIG. 2, the CTU may first be split into the QT structure. Quadtree splitting may be recursive until the size of a splitting block reaches a minimum block size (MinQTSize) of the leaf node permitted in the QT. A first flag (QT_split_flag) indicating whether each node of the QT structure is split into four nodes of a lower layer is encoded by the entropy encoder 155 and signaled to the video decoding apparatus. When the leaf node of the QT is not larger than a maximum block size (MaxBTSize) of a root node permitted in the BT, the leaf node may be further split into at least one of the BT structure or the TT structure. A plurality of split directions may be present in the BT structure and/or the TT structure. For example, there may be two directions, i.e., a direction in which the block of the corresponding node is split horizontally and a direction in which the block of the corresponding node is split vertically. As illustrated in FIG. 2, when the MTT splitting starts, a second flag (mtt_split_flag) indicating whether the nodes are split, and a flag additionally indicating the split direction (vertical or horizontal), and/or a flag indicating a split type (binary or ternary) if the nodes are split are encoded by the entropy encoder 155 and signaled to the video decoding apparatus.

Alternatively, prior to encoding the first flag (QT_split_flag) indicating whether each node is split into four nodes of the lower layer, a CU split flag (split_cu_flag) indicating whether the node is split may also be encoded. When a value of the CU split flag (split_cu_flag) indicates that each node is not split, the block of the corresponding node becomes the leaf node in the split tree structure and becomes the CU, which is the basic unit of encoding. When the value of the CU split flag (split_cu_flag) indicates that each node is split, the video encoding apparatus starts encoding the first flag first by the above-described scheme.

When the QTBT is used as another example of the tree structure, there may be two types, i.e., a type (i.e., symmetric horizontal splitting) in which the block of the corresponding node is horizontally split into two blocks having the same size and a type (i.e., symmetric vertical splitting) in which the block of the corresponding node is vertically split into two blocks having the same size. A split flag (split_flag) indicating whether each node of the BT structure is split into the block of the lower layer and split type information indicating a splitting type are encoded by the entropy encoder 155 and delivered to the video decoding apparatus. Meanwhile, a type in which the block of the corresponding node is split into two blocks asymmetrical to each other may be additionally present. The asymmetrical form may include a form in which the block of the corresponding node is split into two rectangular blocks having a size ratio of 1:3 or may also include a form in which the block of the corresponding node is split in a diagonal direction.

The CU may have various sizes according to QTBT or QTBTTT splitting from the CTU. Hereinafter, a block corresponding to a CU (i.e., the leaf node of the QTBTTT) to be encoded or decoded is referred to as a “current block.” As the QTBTTT splitting is adopted, a shape of the current block may also be a rectangular shape in addition to a square shape.

The predictor 120 predicts the current block to generate a prediction block. The predictor 120 includes an intra predictor 122 and an inter predictor 124.

In general, each of the current blocks in the picture may be predictively coded. In general, the prediction of the current block may be performed by using an intra prediction technology (using data from the picture including the current block) or an inter prediction technology (using data from a picture coded before the picture including the current block). The inter prediction includes both unidirectional prediction and bidirectional prediction.

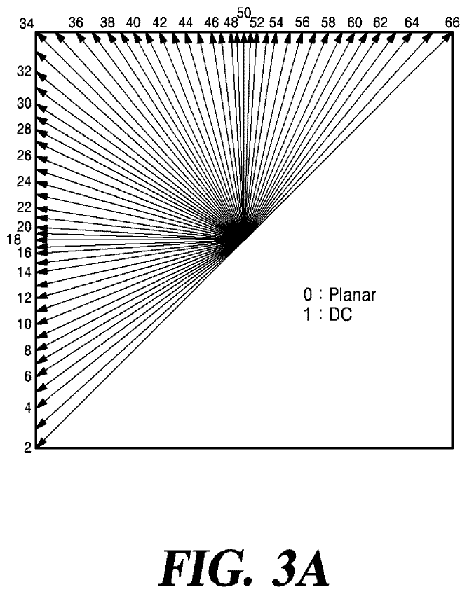

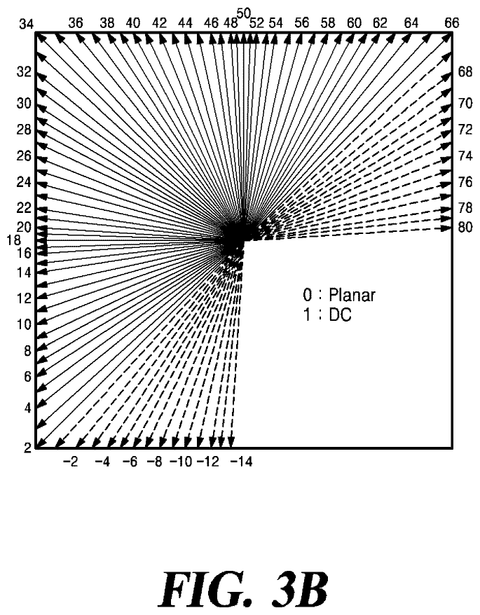

The intra predictor 122 predicts pixels in the current block by using pixels (reference pixels) positioned on a neighbor of the current block in the current picture including the current block. There is a plurality of intra prediction modes according to the prediction direction. For example, as illustrated in FIG. 3A, the plurality of intra prediction modes may include 2 non-directional modes including a Planar mode and a DC mode and may include 65 directional modes. A neighboring pixel and an arithmetic equation to be used are defined differently according to each prediction mode.

For efficient directional prediction for the current block having a rectangular shape, directional modes (#67 to #80, intra prediction modes #-1 to #-14) illustrated as dotted arrows in FIG. 3B may be additionally used. The directional modes may be referred to as “wide angle intra-prediction modes”. In FIG. 3B, the arrows indicate corresponding reference samples used for the prediction and do not represent the prediction directions. The prediction direction is opposite to a direction indicated by the arrow. When the current block has the rectangular shape, the wide angle intra-prediction modes are modes in which the prediction is performed in an opposite direction to a specific directional mode without additional bit transmission. In this case, among the wide angle intra-prediction modes, some wide angle intra-prediction modes usable for the current block may be determined by a ratio of a width and a height of the current block having the rectangular shape. For example, when the current block has a rectangular shape in which the height is smaller than the width, wide angle intra-prediction modes (intra prediction modes #67 to #80) having an angle smaller than 45 degrees are usable. When the current block has a rectangular shape in which the width is larger than the height, the wide angle intra-prediction modes having an angle larger than-135 degrees are usable.

The intra predictor 122 may determine an intra prediction to be used for encoding the current block. In some examples, the intra predictor 122 may encode the current block by using multiple intra prediction modes and may also select an appropriate intra prediction mode to be used from tested modes. For example, the intra predictor 122 may calculate rate-distortion values by using a rate-distortion analysis for multiple tested intra prediction modes and may also select an intra prediction mode having best rate-distortion features among the tested modes.

The intra predictor 122 selects one intra prediction mode among a plurality of intra prediction modes and predicts the current block by using a neighboring pixel (reference pixel) and an arithmetic equation determined according to the selected intra prediction mode. Information on the selected intra prediction mode is encoded by the entropy encoder 155 and delivered to the video decoding apparatus.

The inter predictor 124 generates the prediction block for the current block by using a motion compensation process. The inter predictor 124 searches a block most similar to the current block in a reference picture encoded and decoded earlier than the current picture and generates the prediction block for the current block by using the searched block. In addition, a motion vector (MV) is generated, which corresponds to a displacement between the current block in the current picture and the prediction block in the reference picture. In general, motion estimation is performed for a luma component, and a motion vector calculated based on the luma component is used for both the luma component and a chroma component. Motion information including information on the reference picture and information on the motion vector used for predicting the current block is encoded by the entropy encoder 155 and delivered to the video decoding apparatus.

The inter predictor 124 may also perform interpolation for the reference picture or a reference block in order to increase accuracy of the prediction. In other words, sub-samples between two contiguous integer samples are interpolated by applying filter coefficients to a plurality of contiguous integer samples including two integer samples. When a process of searching a block most similar to the current block is performed for the interpolated reference picture, not integer sample unit precision but decimal unit precision may be expressed for the motion vector. Precision or resolution of the motion vector may be set differently for each target area to be encoded, e.g., a unit such as the slice, the tile, the CTU, the CU, and the like. When such an adaptive motion vector resolution (AMVR) is applied, information on the motion vector resolution to be applied to each target area should be signaled for each target area. For example, when the target area is the CU, the information on the motion vector resolution applied for each CU is signaled. The information on the motion vector resolution may be information representing precision of a motion vector difference to be described below.

Meanwhile, the inter predictor 124 may perform inter prediction by using bi-prediction. In the case of bi-prediction, two reference pictures and two motion vectors representing a block position most similar to the current block in each reference picture are used. The inter predictor 124 selects a first reference picture and a second reference picture from reference picture list 0 (RefPicList0) and reference picture list 1 (RefPicList1), respectively. The inter predictor 124 also searches blocks most similar to the current blocks in the respective reference pictures to generate a first reference block and a second reference block. In addition, the prediction block for the current block is generated by averaging or weighted-averaging the first reference block and the second reference block. In addition, motion information including information on two reference pictures used for predicting the current block and including information on two motion vectors is delivered to the entropy encoder 155. Here, reference picture list 0 may be constituted by pictures before the current picture in a display order among pre-reconstructed pictures, and reference picture list 1 may be constituted by pictures after the current picture in the display order among the pre-reconstructed pictures. However, although not particularly limited thereto, the pre-reconstructed pictures after the current picture in the display order may be additionally included in reference picture list 0. Inversely, the pre-reconstructed pictures before the current picture may also be additionally included in reference picture list 1.

In order to minimize a bit quantity consumed for encoding the motion information, various methods may be used.

For example, when the reference picture and the motion vector of the current block are the same as the reference picture and the motion vector of the neighboring block, information capable of identifying the neighboring block is encoded to deliver the motion information of the current block to the video decoding apparatus. Such a method is referred to as a merge mode.

In the merge mode, the inter predictor 124 selects a predetermined number of merge candidate blocks (hereinafter, referred to as a “merge candidate”) from the neighboring blocks of the current block.

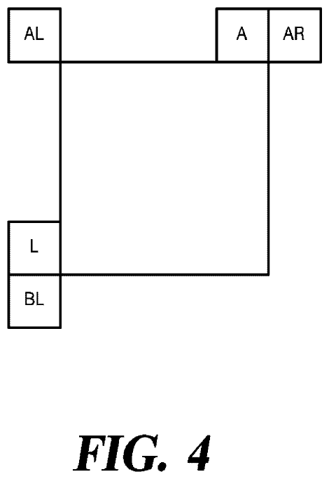

As a neighboring block for deriving the merge candidate, all or some of a left block A0,a bottom left block A1, a top block B0, a top right block B1, and a top left block B2 adjacent to the current block in the current picture may be used as illustrated in FIG. 4. Further, a block positioned within the reference picture (may be the same as or different from the reference picture used for predicting the current block) other than the current picture at which the current block is positioned may also be used as the merge candidate. For example, a co-located block with the current block within the reference picture or blocks adjacent to the co-located block may be additionally used as the merge candidate. If the number of merge candidates selected by the method described above is smaller than a preset number, a zero vector is added to the merge candidate.

The inter predictor 124 configures a merge list including a predetermined number of merge candidates by using the neighboring blocks. A merge candidate to be used as the motion information of the current block is selected from the merge candidates included in the merge list, and merge index information for identifying the selected candidate is generated. The generated merge index information is encoded by the entropy encoder 155 and delivered to the video decoding apparatus.

A merge skip mode is a special case of the merge mode. After quantization, when all transform coefficients for entropy encoding are close to zero, only the neighboring block selection information is transmitted without transmitting residual signals. By using the merge skip mode, it is possible to achieve a relatively high encoding efficiency for images with slight motion, still images, screen content images, and the like.

Hereafter, the merge mode and the merge skip mode are collectively referred to as the merge/skip mode.

Another method for encoding the motion information is an advanced motion vector prediction (AMVP) mode.

In the AMVP mode, the inter predictor 124 derives motion vector predictor candidates for the motion vector of the current block by using the neighboring blocks of the current block. As a neighboring block used for deriving the motion vector predictor candidates, all or some of a left block A0, a bottom left block A1, a top block B0, a top right block B1, and a top left block B2 adjacent to the current block in the current picture illustrated in FIG. 4 may be used. Further, a block positioned within the reference picture (may be the same as or different from the reference picture used for predicting the current block) other than the current picture at which the current block is positioned may also be used as the neighboring block used for deriving the motion vector predictor candidates. For example, a co-located block with the current block within the reference picture or blocks adjacent to the co-located block may be used. If the number of motion vector candidates selected by the method described above is smaller than a preset number, a zero vector is added to the motion vector candidate.

The inter predictor 124 derives the motion vector predictor candidates by using the motion vector of the neighboring blocks and determines motion vector predictor for the motion vector of the current block by using the motion vector predictor candidates. In addition, a motion vector difference is calculated by subtracting motion vector predictor from the motion vector of the current block.

The motion vector predictor may be acquired by applying a pre-defined function (e.g., center value and average value computation, and the like) to the motion vector predictor candidates. In this case, the video decoding apparatus also knows the pre-defined function. Further, since the neighboring block used for deriving the motion vector predictor candidate is a block in which encoding and decoding are already completed, the video decoding apparatus may also already know the motion vector of the neighboring block. Therefore, the video encoding apparatus does not need to encode information for identifying the motion vector predictor candidate. Accordingly, in this case, information on the motion vector difference and information on the reference picture used for predicting the current block are encoded.

Meanwhile, the motion vector predictor may also be determined by a scheme of selecting any one of the motion vector predictor candidates. In this case, information for identifying the selected motion vector predictor candidate is additional encoded jointly with the information on the motion vector difference and the information on the reference picture used for predicting the current block.

The subtractor 130 generates a residual block by subtracting the prediction block generated by the intra predictor 122 or the inter predictor 124 from the current block.

The transformer 140 transforms residual signals in a residual block having pixel values of a spatial domain into transform coefficients of a frequency domain. The transformer 140 may transform residual signals in the residual block by using a total size of the residual block as a transform unit or also split the residual block into a plurality of subblocks and may perform the transform by using the subblock as the transform unit. Alternatively, the residual block is divided into two subblocks, which are a transform area and a non-transform area, to transform the residual signals by using only the transform area subblock as the transform unit. Here, the transform area subblock may be one of two rectangular blocks having a size ratio of 1:1 based on a horizontal axis (or vertical axis). In this case, a flag (cu_sbt_flag) indicates that only the subblock is transformed, and directional (vertical/horizontal) information (cu_sbt_horizontal_flag) and/or positional information (cu_sbt_pos_flag) are encoded by the entropy encoder 155 and signaled to the video decoding apparatus. Further, a size of the transform area subblock may have a size ratio of 1:3 based on the horizontal axis (or vertical axis). In this case, a flag (cu_sbt_quad_flag) dividing the corresponding splitting is additionally encoded by the entropy encoder 155 and signaled to the video decoding apparatus.

Meanwhile, the transformer 140 may perform the transform for the residual block individually in a horizontal direction and a vertical direction. For the transform, various types of transform functions or transform matrices may be used. For example, a pair of transform functions for horizontal transform and vertical transform may be defined as a multiple transform set (MTS). The transformer 140 may select one transform function pair having highest transform efficiency in the MTS and may transform the residual block in each of the horizontal and vertical directions. Information (mts_idx) on the transform function pair in the MTS is encoded by the entropy encoder 155 and signaled to the video decoding apparatus.

The quantizer 145 quantizes the transform coefficients output from the transformer 140 using a quantization parameter and outputs the quantized transform coefficients to the entropy encoder 155. The quantizer 145 may also immediately quantize the related residual block without the transform for any block or frame. The quantizer 145 may also apply different quantization coefficients (scaling values) according to positions of the transform coefficients in the transform block. A quantization matrix applied to quantized transform coefficients arranged in 2 dimensional may be encoded and signaled to the video decoding apparatus.

The rearrangement unit 150 may perform realignment of coefficient values for quantized residual values.

The rearrangement unit 150 may change a 2D coefficient array to a 1D coefficient sequence by using coefficient scanning. For example, the rearrangement unit 150 may output the 1D coefficient sequence by scanning a DC coefficient to a high-frequency domain coefficient by using a zig-zag scan or a diagonal scan. According to the size of the transform unit and the intra prediction mode, vertical scan of scanning a 2D coefficient array in a column direction and horizontal scan of scanning a 2D block type coefficient in a row direction may also be used instead of the zig-zag scan. In other words, according to the size of the transform unit and the intra prediction mode, a scan method to be used may be determined among the zig-zag scan, the diagonal scan, the vertical scan, and the horizontal scan.

The entropy encoder 155 generates a bitstream by encoding a sequence of 1D quantized transform coefficients output from the rearrangement unit 150 by using various encoding schemes including a Context-based Adaptive Binary Arithmetic Code (CABAC), an Exponential Golomb, or the like.

Further, the entropy encoder 155 encodes information, such as a CTU size, a CTU split flag, a QT split flag, an MTT split type, an MTT split direction, etc., related to the block splitting to allow the video decoding apparatus to split the block equally to the video encoding apparatus. Further, the entropy encoder 155 encodes information on a prediction type indicating whether the current block is encoded by intra prediction or inter prediction. The entropy encoder 155 encodes intra prediction information (i.e., information on an intra prediction mode) or inter prediction information (in the case of the merge mode, a merge index and in the case of the AMVP mode, information on the reference picture index and the motion vector difference) according to the prediction type. Further, the entropy encoder 155 encodes information related to quantization, i.e., information on the quantization parameter and information on the quantization matrix.

The inverse quantizer 160 dequantizes the quantized transform coefficients output from the quantizer 145 to generate the transform coefficients. The inverse transformer 165 transforms the transform coefficients output from the inverse quantizer 160 into a spatial domain from a frequency domain to reconstruct the residual block.

The adder 170 adds the reconstructed residual block and the prediction block generated by the predictor 120 to reconstruct the current block. Pixels in the reconstructed current block may be used as reference pixels when intra-predicting a next-order block.

The loop filter unit 180 performs filtering for the reconstructed pixels in order to reduce blocking artifacts, ringing artifacts, blurring artifacts, etc., which occur due to block based prediction and transform/quantization. The loop filter unit 180 as an in-loop filter may include all or some of a deblocking filter 182, a sample adaptive offset (SAO) filter 184, and an adaptive loop filter (ALF) 186.

The deblocking filter 182 filters a boundary between the reconstructed blocks in order to remove a blocking artifact, which occurs due to block unit encoding/decoding, and the SAO filter 184 and the ALF 186 perform additional filtering for a deblocked filtered video. The SAO filter 184 and the ALF 186 are filters used for compensating differences between the reconstructed pixels and original pixels, which occur due to lossy coding. The SAO filter 184 applies an offset as a CTU unit to enhance a subjective image quality and encoding efficiency. On the other hand, the ALF 186 performs block unit filtering and compensates distortion by applying different filters by dividing a boundary of the corresponding block and a degree of a change amount. Information on filter coefficients to be used for the ALF may be encoded and signaled to the video decoding apparatus.

The reconstructed block filtered through the deblocking filter 182, the SAO filter 184, and the ALF 186 is stored in the memory 190. When all blocks in one picture are reconstructed, the reconstructed picture may be used as a reference picture for inter predicting a block within a picture to be encoded afterwards.

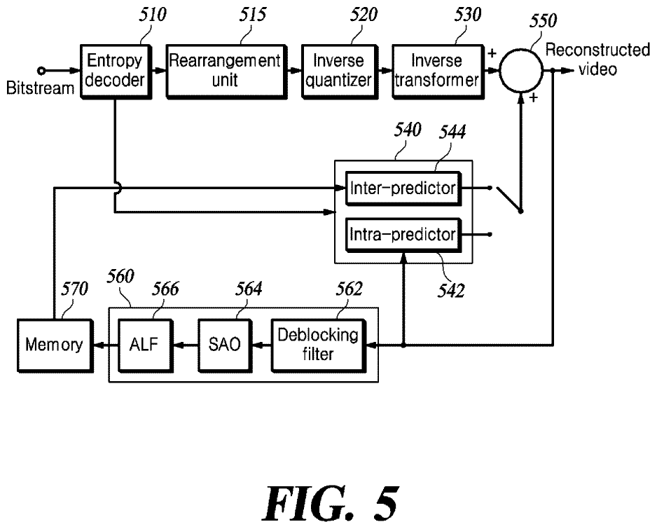

FIG. 5 is a functional block diagram of a video decoding apparatus that may implement the technologies of the present disclosure. Hereinafter, referring to FIG. 5, the video decoding apparatus and components of the apparatus are described.

The video decoding apparatus may include an entropy decoder 510, a rearrangement unit 515, an inverse quantizer 520, an inverse transformer 530, a predictor 540, an adder 550, a loop filter unit 560, and a memory 570.

Similar to the video encoding apparatus of FIG. 1, each component of the video decoding apparatus may be implemented as hardware or software or implemented as a combination of hardware and software. Further, a function of each component may be implemented as the software, and a microprocessor may also be implemented to execute the function of the software corresponding to each component.

The entropy decoder 510 extracts information related to block splitting by decoding the bitstream generated by the video encoding apparatus to determine a current block to be decoded and extracts prediction information required for reconstructing the current block and information on the residual signals.

The entropy decoder 510 determines the size of the CTU by extracting information on the CTU size from a sequence parameter set (SPS) or a picture parameter set (PPS) and splits the picture into CTUs having the determined size. In addition, the CTU is determined as a highest layer of the tree structure, i.e., a root node, and split information for the CTU may be extracted to split the CTU by using the tree structure.

For example, when the CTU is split by using the QTBTTT structure, a first flag (QT_split_flag) related to splitting of the QT is first extracted to split each node into four nodes of the lower layer. In addition, a second flag (mtt_split_flag), a split direction (vertical/horizontal), and/or a split type (binary/ternary) related to splitting of the MTT are extracted with respect to the node corresponding to the leaf node of the QT to split the corresponding leaf node into an MTT structure. As a result, each of the nodes below the leaf node of the QT is recursively split into the BT or TT structure.

As another example, when the CTU is split by using the QTBTTT structure, a CU split flag (split_cu_flag) indicating whether the CU is split is extracted. When the corresponding block is split, the first flag (QT_split_flag) may also be extracted. During a splitting process, with respect to each node, recursive MTT splitting of 0 times or more may occur after recursive QT splitting of 0 times or more. For example, with respect to the CTU, the MTT splitting may immediately occur, or on the contrary, only QT splitting of multiple times may also occur.

As another example, when the CTU is split by using the QTBT structure, the first flag (QT_split_flag) related to the splitting of the QT is extracted to split each node into four nodes of the lower layer. In addition, a split flag (split_flag) indicating whether the node corresponding to the leaf node of the QT is further split into the BT, and split direction information are extracted.

Meanwhile, when the entropy decoder 510 determines a current block to be decoded by using the splitting of the tree structure, the entropy decoder 510 extracts information on a prediction type indicating whether the current block is intra predicted or inter predicted. When the prediction type information indicates the intra prediction, the entropy decoder 510 extracts a syntax element for intra prediction information (intra prediction mode) of the current block. When the prediction type information indicates the inter prediction, the entropy decoder 510 extracts information representing a syntax element for inter prediction information, i.e., a motion vector and a reference picture to which the motion vector refers.

Further, the entropy decoder 510 extracts quantization related information and extracts information on the quantized transform coefficients of the current block as the information on the residual signals.

The rearrangement unit 515 may change a sequence of 1D quantized transform coefficients entropy-decoded by the entropy decoder 510 to a 2D coefficient array (i.e., block) again in a reverse order to the coefficient scanning order performed by the video encoding apparatus.

The inverse quantizer 520 dequantizes the quantized transform coefficients and dequantizes the quantized transform coefficients by using the quantization parameter. The inverse quantizer 520 may also apply different quantization coefficients (scaling values) to the quantized transform coefficients arranged in 2D. The inverse quantizer 520 may perform dequantization by applying a matrix of the quantization coefficients (scaling values) from the video encoding apparatus to a 2D array of the quantized transform coefficients.

The inverse transformer 530 generates the residual block for the current block by reconstructing the residual signals by inversely transforming the dequantized transform coefficients into the spatial domain from the frequency domain.

Further, when the inverse transformer 530 inversely transforms a partial area (subblock) of the transform block, the inverse transformer 530 extracts a flag (cu_sbt_flag) that only the subblock of the transform block is transformed, directional (vertical/horizontal) information (cu_sbt_horizontal_flag) of the subblock, and/or positional information (cu_sbt_pos_flag) of the subblock. The inverse transformer 530 also inversely transforms the transform coefficients of the corresponding subblock into the spatial domain from the frequency domain to reconstruct the residual signals and fills an area, which is not inversely transformed, with a value of “0” as the residual signals to generate a final residual block for the current block.

Further, when the MTS is applied, the inverse transformer 530 determines the transform index or the transform matrix to be applied in each of the horizontal and vertical directions by using the MTS information (mts_idx) signaled from the video encoding apparatus. The inverse transformer 530 also performs inverse transform for the transform coefficients in the transform block in the horizontal and vertical directions by using the determined transform function.

The predictor 540 may include an intra predictor 542 and an inter predictor 544. The intra predictor 542 is activated when the prediction type of the current block is the intra prediction, and the inter predictor 544 is activated when the prediction type of the current block is the inter prediction.

The intra predictor 542 determines the intra prediction mode of the current block among the plurality of intra prediction modes from the syntax element for the intra prediction mode extracted from the entropy decoder 510. The intra predictor 542 also predicts the current block by using neighboring reference pixels of the current block according to the intra prediction mode.

The inter predictor 544 determines the motion vector of the current block and the reference picture to which the motion vector refers by using the syntax element for the inter prediction mode extracted from the entropy decoder 510.

The adder 550 reconstructs the current block by adding the residual block output from the inverse transformer 530 and the prediction block output from the inter predictor 544 or the intra predictor 542. Pixels within the reconstructed current block are used as a reference pixel upon intra predicting a block to be decoded afterwards.

The loop filter unit 560 as an in-loop filter may include a deblocking filter 562, an SAO filter 564, and an ALF 566. The deblocking filter 562 performs deblocking filtering a boundary between the reconstructed blocks in order to remove the blocking artifact, which occurs due to block unit decoding. The SAO filter 564 and the ALF 566 perform additional filtering for the reconstructed block after the deblocking filtering in order to compensate differences between the reconstructed pixels and original pixels, which occur due to lossy coding. The filter coefficients of the ALF are determined by using information on filter coefficients decoded from the bitstream.

The reconstructed block filtered through the deblocking filter 562, the SAO filter 564, and the ALF 566 is stored in the memory 570. When all blocks in one picture are reconstructed, the reconstructed picture may be used as a reference picture for inter predicting a block within a picture to be encoded afterwards.

The present disclosure in some embodiments relates to encoding and decoding video images as described above. More specifically, the present disclosure provides a video coding method and an apparatus for generating a predictor of a chroma channel by using multiple reference lines in intra-predicting the current block based on an Intra-Prediction Mode (IPM) or a Cross-Component Linear Model (CCLM).

The following embodiments may be performed by the intra predictor 122 in the video encoding device. The following embodiments may also be performed by the intra predictor 542 in the video decoding device.

The video encoding device when encoding the current block may generate signaling information associated with the present embodiments in terms of optimizing rate distortion. The video encoding device may use the entropy encoder 155 to encode the signaling information and may transmit the encoded signaling information to the video decoding device. The video decoding device may use the entropy decoder 510 to decode, from the bitstream, the signaling information associated with decoding the current block.

In the following description, the term “target block” may be used interchangeably with the current block or coding unit (CU). The term “target block” may refer to some region of the coding unit.

Further, the value of one flag being true indicates when the flag is set to 1. Additionally, the value of one flag being false indicates when the flag is set to 0.

### I. Intra-prediction Techniques for Chroma Channels

Different techniques are introduced to improve coding efficiency by using intra prediction.

In the VVC (Versatile Video Coding) technology, the intra-prediction mode of the luma block has 65 (i.e., 2 to 66) subdivided directional modes in addition to the non-directional modes (i.e., planar and DC), as illustrated in FIG. 3A. The 65 directional modes, planar and DC modes, are collectively referred to as 67 IPMs.

Depending on the prediction direction utilized by the luma block, the chroma block may also have limited access to the intra prediction of these subdivided directional modes. However, the intra prediction of the chroma block may not always utilize the various directional modes available to the luma block except for the horizontal and vertical directions. To be able to use these different directional modes, the current prediction mode of the chroma block needs to be set to DM mode. By setting this to DM mode, the current chroma block may utilize directional modes other than the horizontal and vertical of the luma block.

When a chroma block is encoded, the intra-prediction modes that are often used or are the most basic to maintain image quality include planar, DC, vertical, horizontal modes, and DM. In DM, the intra-prediction mode of the luma block that spatially corresponds to the current chroma block is utilized as the intra-prediction mode of the chroma block.

The video encoding device may signal to the video decoding device whether the intra-prediction mode of the chroma block is in DM. In doing so, the video encoding device may communicate the DM to the video decoding device in many different ways. For example, the video encoding device may set intra_chroma_pred_mode, which is information for indicating the intra-prediction mode of the chroma block, to a specific value and may transmit intra_chroma_pred_mode to the video decoding device to indicate whether the intra-prediction mode of the chroma block is DM.

If the chroma block is encoded in intra-prediction mode, the video encoding device may set the intra-prediction mode IntraPredModeC of the chroma block according to Table 1.

Hereinafter, to distinguish between intra_chroma_pred_mode and IntraPredModeC, which are information related to the intra-prediction mode of the chroma block, IntraPredModeC and intra_chroma_pred_mode are denoted as chroma intra-prediction mode indicator and chroma intra-prediction mode, respectively.

TABLE 1

| cclm_ | cclm_ | intra_ | lumaIntraPredMode | | | | |
|---|---|---|---|---|---|---|---|
| mode_ | mode_ | chroma_ | | | | | X |
| flag | idx | pred_mode | 0 | 50 | 18 | 1 | (0 <= X <= 66) |
| 0 | — | 0 | 66 | 0 | 0 | 0 | 0 |
| 0 | — | 1 | 50 | 66 | 50 | 50 | 50 |
| 0 | — | 2 | 18 | 18 | 66 | 18 | 18 |
| 0 | — | 3 | 1 | 1 | 1 | 66 | 1 |
| 0 | — | 4 | 0 | 50 | 18 | 1 | X |
| 1 | 0 | — | 81 | 81 | 81 | 81 | 81 |
| 1 | 1 | — | 82 | 82 | 82 | 82 | 82 |
| 1 | 2 | — | 83 | 83 | 83 | 83 | 83 |

Here, lumaIntraPredMode is the intra-prediction mode of the luma block corresponding to the current chroma block (hereinafter, the “luma intra-prediction mode”). The lumaIntraPredMode represents one of the prediction modes illustrated in FIG. 3A. For example, in Table 1, lumaIntraPredMode=0 refers to the planar prediction mode, and lumaIntraPredMode=1 refers to the DC prediction mode. Cases with lumaIntraPredMode of 18, 50, and 66 indicate directional modes, referred to as horizontal, vertical, and VDIA, respectively. On the other hand, cases with intra_chroma_pred_mode=0, 1, 2, and 3 refer to planar, vertical, horizontal, and DC prediction modes, respectively. The case of intra_chroma_pred_mode=4 is the DM, and the value of IntraPredModeC, the chroma intra-prediction mode, is set equal to the value of lumaIntraPredMode.

Meanwhile, the process of parsing the intra-prediction mode of the chroma block, performed by the video decoding device, is shown in Table 2.

TABLE 2

| | |
|---|---|
| | if( CclmEnabled ) |
| cclm_mode_flag | |
| | if( cclm_mode_flag ) |
| cclm_mode_idx | |
| | else |
| intra_chroma_pred_mode | |

The video decoding device parses the cclm_mode_flag which indicates whether CCLM mode is enabled or disabled. If cclm_mode_flag is 1 to enable CCLM mode, the video decoding device parses cclm_mode_idx which indicates the CCLM mode. Depending on the value of cclm_mode_idx, the CCLM mode may be indicated to be one of the three modes. On the other hand, if the cclm_mode_flag is 0, indicating that the CCLM mode is not used, the video decoding device parses intra_chroma_pred_mode which indicates the intra-prediction mode, as described above.

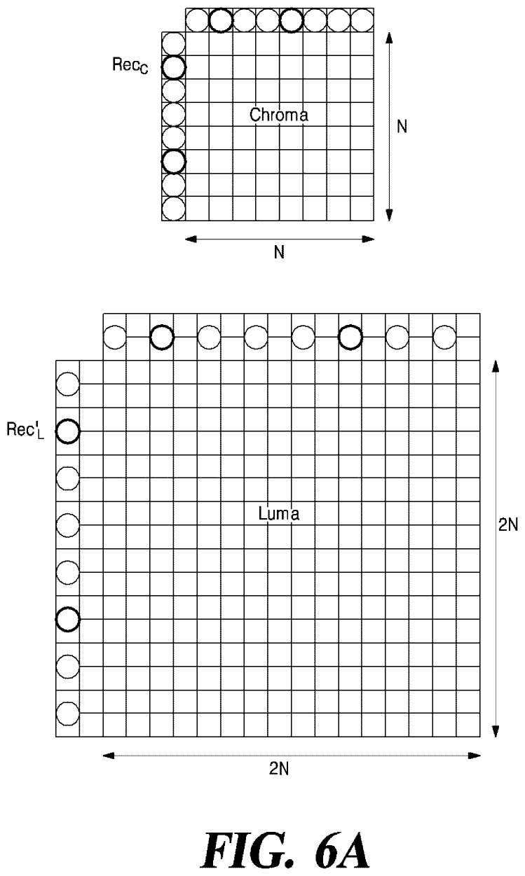

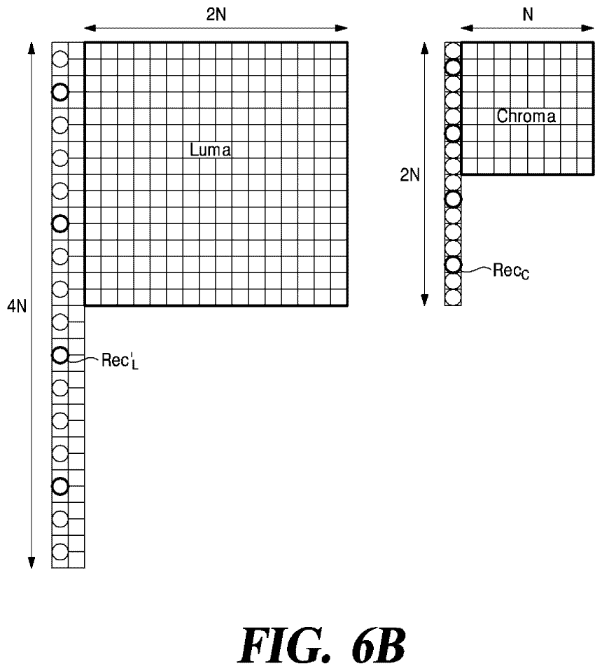

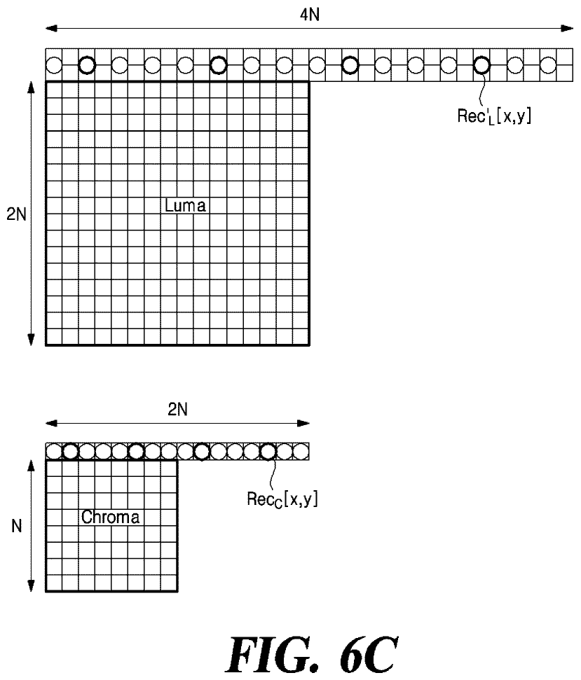

FIGS. 6A through 6C are diagrams illustrating neighboring reference pixels used in each of CCLM modes.

When a CCLM mode is applied for the intra prediction of the current chroma block, the video decoding device determines a region in the luma image corresponding to the current chroma block, i.e., determines a “corresponding luma region” as called hereinafter. For the prediction of a linear model, the left reference pixel and the top reference pixel of the corresponding luma region and the left reference pixel and the top reference pixel of the target chroma block may be utilized. Hereinafter, the left reference pixels and the top reference pixels are combined and referred to as reference pixels, neighboring pixels, or adjacent pixels. Further, reference pixels of the chroma channel are denoted as chroma reference pixels, and reference pixels of the luma channel are denoted as luma reference pixels. In the examples of FIGS. 6A to 6C, the size of the chroma block, i.e., the number of pixels, is represented as N×N, where N is a natural number.

In CCLM prediction, a prediction block that is a predictor of the target chroma block is generated by deriving the linear model between the reference pixels of the corresponding luma region and the reference pixels of the chroma block and then applying the linear model to the reconstructed pixels of the corresponding luma region. For example, as illustrated in FIGS. 6A to 6C, four pairs of pixels obtained by combining pixels on a line of neighboring pixels of the current chroma block with pixels in a corresponding luma region may be used to derive the linear model. The video decoding device may derive α, β representing the linear model as shown in Equation 1 for the four pairs of pixels.

$$α = \frac{{Y}_{b} - {Y}_{a}}{{X}_{b} - {X}_{a}} , β = {Y}_{a} - α \cdot {X}_{a} \qquad [ Equation 1 ]$$

Here, for the corresponding luma pixels of the four pairs of pixels, Xₐ and X_{b} represent the average of the two minimum values and the average of the two maximum values, respectively. Additionally, for the chroma pixels, Yₐ and Y_{b} represent the average of the two minimum values and the average of the two maximum values, respectively. Then, the video decoding device may generate a predictor pred_{C}(i,j) of the current chroma block from the pixel values rec′_{L}(i,j) of the corresponding luma region by using the linear model, as shown in Equation 2.

pred_{C}(i,j)=α·rec′_{L}(i,j)+β [Equation 2]

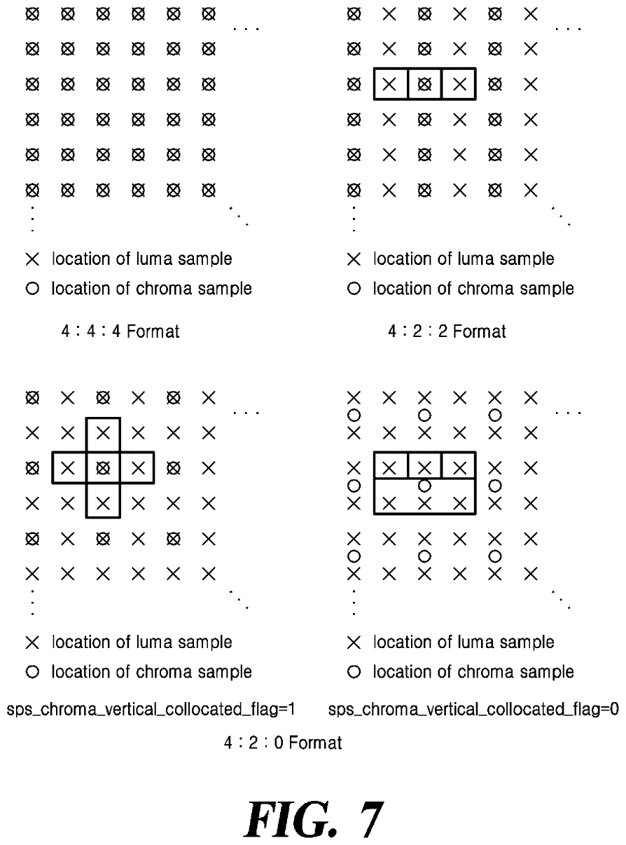

FIG. 7 is a diagram illustrating downsampling filters according to color formats.

Before the linear model is applied, the video decoding device checks for equality in size between the corresponding luma region and the current chroma block. If their sizes are different depending on the subsampling scheme of the chroma channel, the video decoding device may adjust the size of the corresponding luma region to be equal to the size of the current chroma block by downsampling the corresponding luma region by using a filter appropriate to each case, as illustrated in FIG. 7.

As described above, the CCLM mode is divided into three modes, CCLM_LT, CCLM_L, and CCLM_T, depending on the location of the neighboring pixels used in the derivation of the linear model. CCLM_LT mode uses two pixels in each direction from the neighboring pixels adjacent to the left and top of the current chroma block, as illustrated in FIG. 6A. CCLM_L mode uses four pixels from the neighboring pixels adjacent to the left of the current chroma block, as illustrated in FIG. 6B. Finally, the CCLM_T mode utilizes four pixels from the neighboring pixels adjacent to the top of the current chroma block, as illustrated in FIG. 6C.

The Most Probable Mode (MPM) technique utilizes the intra-prediction mode of neighboring blocks for the intra prediction of the current block. The video encoding device generates an MPM list to include intra-prediction modes derived from predefined locations spatially adjacent to the current block. When applying MPM mode, the video encoding device may send a flag, intra_luma_mpm_flag, to the video decoding device indicating whether the MPM list is to be used. If intra_luma_mpm_flag is not present, intra_luma_mpm_flag is inferred to be 1. The video encoding device may also send the MPM index, intra_luma_mpm_idx, instead of the index of the prediction mode, to improve the coding efficiency of the intra-prediction mode.

The Multiple Reference Line (MRL) technique, when the current block is predicted according to the intra-prediction technique, may use not only the reference line adjacent to the current block but also pixels that exist further away as reference pixels. At this time, pixels with the same distance from the current block are grouped and named as a reference line. The MRL technique performs intra prediction of the current block by using the pixels located on the selected reference line.

The video encoding device signals the reference line index_intra_luma_ref_idx to the video decoding device to indicate the reference line to use when performing the intra prediction. For each index, the bit allocated may be represented as shown in Table 3.

TABLE 3

| intra_luma_ref_idx | Bit allocation |
|---|---|
| 0 | 0 |
| 1 | 10 |
| 2 | 11 |

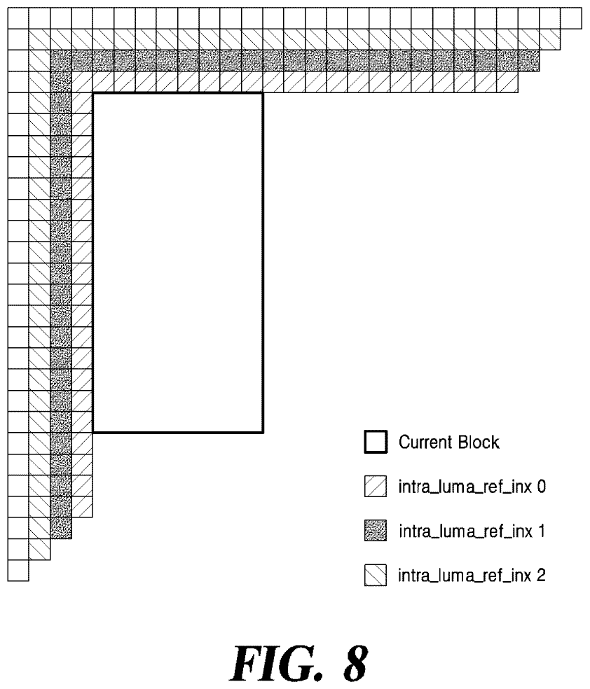

The video decoding device may consider whether to use additional reference lines by applying the MRL to the intra-prediction modes that are signaled according to the MPM, except for planar among the intra-prediction modes. The reference line represented by each intra_luma_ref_idx is illustrated in FIG. 8. In the VVC technology, the video decoding device selects one of the three reference lines that are close in distance to the current block and uses it for the intra prediction of the current block. The reference line index of intra_luma_ref_idx used for prediction, and the syntax related to the signaling of the prediction mode of the current block are shown in Table 4.

TABLE 4

```
    } else {
      if( sps_mrl_enabled_flag && (
( y0 % CtbSizeY ) > 0 ) )
        intra_luma_ref_idx
      if( sps_isp_enabled_flag && intra_luma_ref_idx
= = 0 &&
          ( cb Width <= MaxTbSizeY &&
cbHeight <= MaxTbSizeY ) &&
          ( cbWidth * cbHeight >
MinTbSize Y * MinTbSizeY ) &&
          !cu act_enabled_flag )
        intra_subpartitions_mode_flag
      if( intra_subpartitions_mode_flag = = 1 )
        intra_subpartitions_split_flag
      if( intra_luma_ref_idx = = 0 )
        intra_luma_mpm_flag[ x0 ][ y0 ]
      if( intra_luma_mpm_flag[ x0 ][ y0 ] ) {
        if( intra_luma_ref_idx = = 0 )
  intra_luma_not_planar_flag[ x0 ][ y0 ]
        if( intra_luma_not_planar_flag[ x0 ][ y0 ] )
          intra_luma_mpm_idx[ x0 ][ y0 ]
      } else
        intra_luma_mpm_remainder[ x0 ][ y0 ]
    }
```

First, the video encoding device parses the intra_luma_ref_idx to determine the reference line index to use for prediction. Since the Intra Sub-Partitions (ISP) technique is applicable when the reference line index is zero, the video encoding device does not parse information related to ISP when the reference line index is non-zero.

The MRL technique and MPM mode may be combined as follows.

First, if intra_luma_ref_idx is 0, a flag, intra_luma_not_planar_flag, indicating whether the planar mode is to be used, may be signaled from the video encoding device to the video decoding device. If intra_luma_not_planar_flag is false, the intra-prediction mode may be set to planar mode, and if intra_luma_not_planar_flag is true, intra_luma_mpm_idx may be additionally signaled. If intra_luma_not_planar_flag is not present, intra_luma_not_planar_flag may be inferred to be 1.

Thereafter, if intra luma_ref_idx is non-zero, the planar mode is not used. Therefore, intra_luma_not_planar_flag is not sent and is assumed to be true. Additionally, since intra_luma_not_planar_flag is true, intra_luma_mpm_idx may be signaled.

On the other hand, in terms of intra prediction of the chroma channel, current MRL techniques suffer from two issues.

First, when prediction is performed according to intra-prediction mode (IPM) for the chroma channel, the process uses pixels on one neighboring reference line immediately adjacent to the current block. Since the luma channel may perform better by using additional reference lines, the chroma channel may not always have the best prediction performance by using the neighboring reference line alone. Namely, existing techniques have an inefficient side for the inability to use multiple reference lines for the prediction of chroma blocks. The first issue can be resolved by using multiple reference lines to predict chroma blocks according to IPM.

Second, conventional CCLM techniques use only a limited number of fixedly positioned reference lines to select the reference pixels used to generate the linear relation between the luma and chroma channels. The linear relation, which is derived from the pixels on the reference line adjacent to the current chroma block and the correspondingly positioned luma pixels according to conventional CCLM techniques, may not always best represent the relationship between the current chroma block and the corresponding luma region. However, conventional MRL minds no combination with CCLM. So, the reference pixels of the chroma channel used for CCLM linear relation can only be selected from one fixed reference line. A separate setting of the reference line to hold the reference pixels of the luma channel from that of the reference line to hold the reference pixels of the chroma channels is desirable but not achievable. The second issue can be resolved by using multiple reference lines per channel to derive a linear relation when chroma blocks are predicted according to CCLM.

In the following, some examples are described depending on the prediction mode (IPM or CCLM) of the chroma block for resolving the above-mentioned issues.

When the reference line of a chroma channel is determined, the video decoding device may apply the following examples separately for the two chroma channels, Cb and Cr, to determine the reference line of each independently. Alternatively, the video decoding device may consider only Cb or Cr, or both Cb and Cr simultaneously, to use the same reference line regardless of the type of chroma channel. Further, while prior art MRL techniques can refer to three reference lines, the video decoding device in the present disclosure may consider multiple N reference lines (where Nis a natural number), such as more than three of them.

The chroma channel may be applied with subsampling (4:4:4, 4:2:2, 4:2:0) that causes the luma channel and the chroma channel to have different picture sizes for efficient encoding. Subsampling changes the position of the mapped chroma pixels depending on the phase. Therefore, when applying subsampling, the best reference line for generating the relation between channels may change for the prediction of the current chroma block according to IPM or CCLM. To ensure that the present disclosure, rather than the prior art, is applied to any subsampling scheme, the applicability of the present disclosure may be controlled at a higher level, such as a sequence or picture. To enable the applicability of each example (MRL of the chroma channel), the video encoding device signals the sps_chroma_mrl_enabled_flag or the pps_chroma_mrl_enabled_flag to the video decoding device at a higher level.

Generally, the subsampling method within a picture stays the same, but when multiple scenes are edited to form a picture, such as screen content, different subsampling methods may be used per frame or location in the picture. The video encoding device may vary how the chroma channel uses multiple reference lines per CU or frame by signaling the subsampling method. For example, a method of selecting one of the multiple reference lines according to any subsampling method may be set in the form of a lookup table (LUT), and an optimal reference line selection method may be selected based on the LUT. The subsampling method per picture region or frame is signaled to the video decoding device. At this time, the subsampling method may be transmitted for each CU by using sub_sampling_idx which is an index indicating the subsampling method. On the other hand, the subsampling methods of the previous CU and the current CU may match with a high probability. Therefore, to improve coding efficiency, when the subsampling method is changed, sub_sampling_idx_delta, the amount of change in the index of the subsampling method, may be transmitted as additional information.

### II. When the Prediction Mode of the Current Chroma Block is IPM

The following examples are described about the video encoding device but may be equally applicable to the video decoding device.

### <Example 1> Signaling One Reference Line of the Multiple Reference Lines

In this example, the video encoding device selects one of the multiple reference lines when the current chroma block is predicted according to the IPM, and signals information of the selected reference line. For this purpose, the present disclosure may use signaling methods including (Example 1-1) signaling a reference line index of the chroma block separately from the luma channel, (Example 1-2) signaling a difference between the reference line indices of the representative luma block and the chroma block, or (Example 1-3) signaling that the reference line indices of the representative luma block and the chroma block are the same.

### <Example 1-1> Signaling the Reference Line Index of the Chroma Block Separately from The Luma Channel

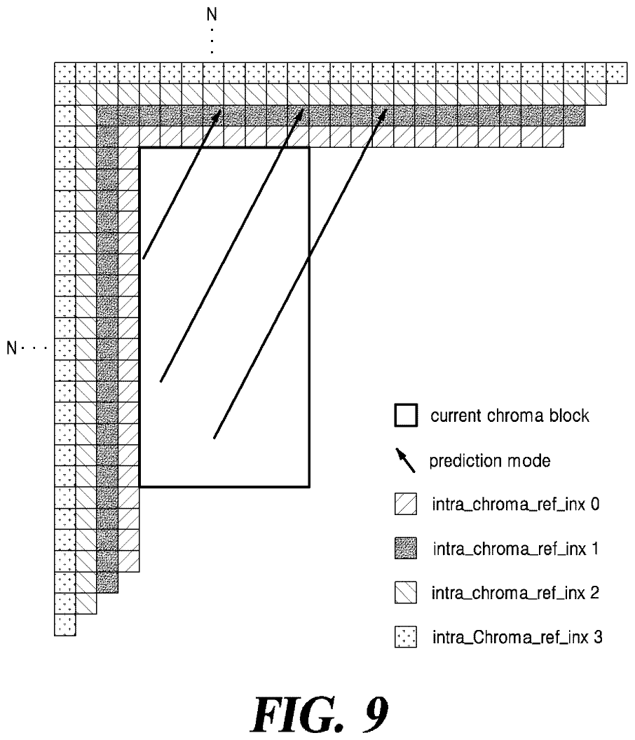

In this example, the video encoding device signals intra_chroma_ref_idx indicating a reference line of the chroma channel separately from the luma channel. For example, as illustrated in FIG. 9, a reference line that is not immediately adjacent to the boundary of the current chroma block (i.e., where intra_chroma_ref_idx is non-zero), and is one pixel away, may be used for prediction. In this case, intra_chroma_ref_idx may be signaled as 1.

The syntax elements required for this example are as follows.

intra_chroma_ref_idx indicates an index indicating the reference line of the current chroma block and may have a value equal to or greater than 0. If intra_chroma_ref_idx is not present, intra_chroma_ref_idx may be inferred to be 0.

Specific pseudocode according to this example may be realized as follows. The pseudocode below illustrates the case where the reference line index of the chroma channel is parsed first.

```
Parsing chroma channel reference line index
(intra_chroma_ref_idx)
if (using adjacent reference line)
  Parsing CCLM-related signals
if (prediction mode is not CCLM)
  Parsing prediction mode
```

According to the pseudocode described above, the required syntax for transmission is shown in Table 5.

TABLE 5

```
    intra_chroma_ref_idx
      if( CclmEnabled &&
intra_chroma_ref_idx = = 0)
  cclm_mode_flag
      if( cclm_mode_flag )
        cclm_mode_idx
      else
  intra_chroma_pred_mode
```

On the other hand, the pseudocode below shows the case where the prediction mode of the chroma channel is parsed first.

```
Parsing CCLM-related signals
if (prediction mode is not CCLM) {
  Parsing prediction mode
  Parsing chroma channel reference line index
  (intra_chroma_ref_idx)
}
```

According to the pseudocode described above, the required syntax for transmission is shown in Table 6.

TABLE 6

```
    if( CclmEnabled )
cclm_mode_flag
    if( cclm_mode_flag )
      cclm_mode_idx
    else {
intra_chroma_pred_mode
intra_chroma_ref_idx
  }
```

The present example has the advantage of being relatively simple and computationally lightweight, making it suitable for applications that require these characteristics. However, even when the reference line index values in the luma channel and the chroma channel are the same or similar, the same reference line indexes in the luma channel and the chroma channel may be signaled separately, without taking advantage of their redundancy or similarity. Examples to remedy this inefficiency are described.

### <Example 1-2> Signaling the Difference Between the Reference Line Indexes of Representative Luma and Chroma Blocks

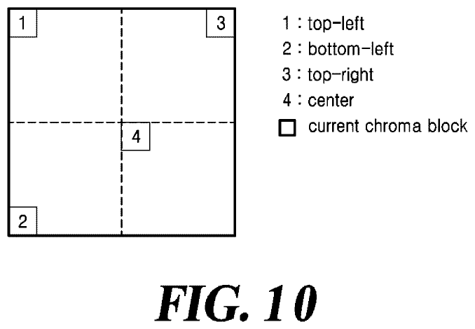

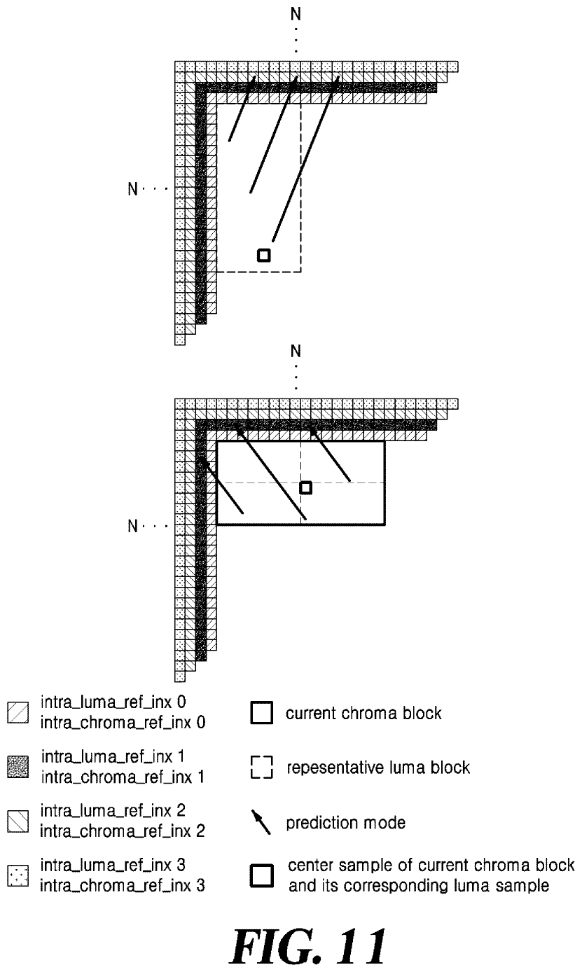

In this example, the video encoding device signals a difference between a reference line index of a representative luma block and a reference line index of the current chroma block. The representative luma block is defined as a block containing luma pixels corresponding to pixels at a particular position, e.g., top left, bottom left, top right, center, and the like of the current chroma block, as shown in the example of FIG. 10. The position may be predefined or signaled. For example, as in the example of FIG. 11, a block containing luma pixels corresponding to pixels in the center position of the current chroma block is defined as a representative luma block, and the reference line index of that luma block may be used in the calculation of the index difference.

When the reference line of the representative luma block is represented by intra_luma_ref_idx, the video encoding device may encode a difference between the reference line index of the current chroma block and the reference line index of the representative luma block. The difference is represented by the sign (+, −) that is intra_ref_idx_diff_sign and the absolute value that is intra_ref_idx_diff. intra_chroma_ref_idx is the reference line index of the current chroma block, which is derived from the difference and is expressed as shown in Equation 3 by using the signaled reference line index and the index difference.

$$intra\_chroma \_ref \_idx = \{ \begin{matrix}intra\_luma \_ref \_idx - intra\_ref \_idx \_diff \\ ( intra\_ref \_idx \_diff \_sign = 0 ) \\ inta\_luma \_ref \_idx + intra\_ref \_idx \_diff \\ ( intra\_ref \_idx \_diff \_sign = 1 )\end{matrix} \qquad [ Equation 3 ]$$

In the example of FIG. 11, intra_luma_ref_idx is 2 and intra_chroma_ref_idx is 1, so intra_ref_idx_diff_sign and intra_ref_idx_diff are signaled as 0 and 1, respectively.

The following syntax elements are required for this example. One or more of these syntax elements may be used.

intra_luma_ref_idx indicates the reference line index of the representative luma block and may have a value equal to or greater than 0.

intra_ref_idx_diff represents the absolute value of the difference between the reference line index (intra_luma_ref_idx) of the representative luma block and the reference line index (intra_chroma_ref_idx) of the current chroma block and may have an integer value greater than or equal to 0. If this value is 0, intra_ref_idx_diff_sign is not signaled.

intra_ref_idx_diff_sign indicates the sign of the difference between the reference line index of the representative luma block (intra_luma_ref_idx) and the reference line index of the current chroma block (intra_chroma_ref_idx). Its value of 0 may indicate a negative difference, and its value of 1 may indicate a positive difference.

Specific pseudocode according to the present example may be realized as follows. The pseudocode below illustrates the case where the reference line information of the chroma channel is parsed first.

```
Parsing absolute value of reference line index difference
(intra_ref_idx_diff)
if (absolute value of reference line index difference is not zero)
  Parsing sign of reference line index difference
  (intra_ref_idx_diff_sign)
if (using adjacent reference line)
  Parsing CCLM-related signals
if (prediction mode is not CCLM)
  Parsing prediction mode
```

According to the pseudocode described above, the syntax required for transmission is shown in Table 7.

TABLE 7

```
    intra_ref_idx_diff
    if( intra_ref_idx_diff !=
0)
  intra_ref_idx_diff_sign
    if( CclmEnabled &&
intra_chroma_ref_idx = = 0)
  cclm_mode_flag
    if( cclm_mode_flag )
      cclm_mode_idx
    else
  intra_chroma_pred_mode
```

On the other hand, the pseudocode below shows the case where the prediction mode of the chroma channel is parsed first.

```
Parsing CCLM-related signals
if (prediction mode is not CCLM)
  Parsing prediction mode
if (prediction mode is IPM) {
  Parsing absolute value of reference line index difference
  (intra_ref_idx_diff)
  if (absolute value of reference line index difference is not zero)
    Parsing sign of reference line index difference
    (intra_ref_idx_diff_sign)
}
```

According to the pseudocode described above, the required syntax for transmission is shown in Table 8.

TABLE 8

```
        if( CclmEnabled )
  cclm_mode_flag
        if( cclm_mode_flag )
          cclm_mode_idx
        else {
  intra_chroma_pred_mode
  intra_ref_idx_diff
          if
(intra_ref_idx_diff != 0)
      intra_ref_idx_diff_sign
    }
```

### <Example 1-3> Signal that the Reference Line Indexes of the Representative Luma Block And the Chroma Block are the Same

In this example, the video encoding device signals that the reference line index of the representative luma block and the reference line index of the current chroma block are the same. If they are different, the video encoding device signals the reference line index of the current chroma block. At this time, Example 1-1 for transmitting the reference line index of the chroma block, Example 1-2 for transmitting the difference between the representative luma block and the reference line index of the chroma block, and the like may be used. Further, the representative luma block is defined the same as Example 1-2.

When the reference line of the representative luma block is represented by intra_luma_ref_idx, the video encoding device signals the intra_ref_eq_flag and thereby signals whether the reference line index of the current chroma block and the reference line index of the representative luma block are equal. In the example of FIG. 11, intra luma_ref_idx is 2 and intra_chroma_ref_idx is 1, which are different, so intra_ref_eq_flag is signaled as 0, and additional information indicating the reference line of the chroma block is transmitted.

The following syntax elements are required for this example. One or more of these syntax elements may be used.

intra luma_ref_idx indicates the reference line index of the representative luma block and may have a value equal to or greater than 0.

intra_ref_eq_flag indicates whether the reference line index (intra_luma_ref_idx) of the representative luma block and the reference line index (intra_chroma_ref_idx) of the current chroma block are equal, and may have a value of 0 or 1. Its value of 1 indicates that intra luma_ref_idx and intra_chroma_ref_idx are identical. Its value of 0 indicates that they are different, and the information of the reference line of the chroma block may be additionally transmitted.

Specific pseudocode according to the present example may be realized as follows. The pseudocode below shows a case where the reference line-related information is parsed first.

```
Parsing information on matching of reference line indices
(intra_ref_eq_flag)
if(representative luma block and chrome block have
different reference lines)
  Parsing reference line index of chroma block
  (intra_chroma_ref_idx)
if (using adjacent reference line)
  Parsing CCLM-related signals
if (prediction mode is not CCLM)
  Parsing prediction mode
```

According to the pseudocode described above, the required syntax for transmission is shown in Table 9.

TABLE 9

```
    intra_ref_eq_flag
    if( intra_ref_eq_flag ==
0)
  intra_chroma_ref_ idx
    if( CclmEnabled &&
intra_chroma_ref_idx = = 0)
  cclm_mode_flag
    if( cclm_mode_flag )
      cclm_mode_idx
    else
  intra_chroma_pred_mode
```

On the other hand, the pseudocode below shows the case where the prediction mode of the chroma channel is parsed first.

```
Parsing CCLM-related signals
if (prediction mode is not CCLM) {
  Parsing prediction mode
  Parsing information on matching of reference
  line indices (intra_ref_eq_flag)
  if(representative luma block and chrome block
  have different reference lines)
    Parsing reference line index of chroma block
    (intra_chroma_ref_idx)
}
```

According to the pseudocode described above, the required syntax for transmission is shown in Table 10.

TABLE 10

```
    if( CclmEnabled )
cclm_mode_flag
    if( cclm_mode_flag )
      cclm_mode_idx
    else {
intra_chroma_pred_mode
intra_ref_eq_flag
if( intra_ref_eq_flag == 0)
  intra_chroma_ref_idx
    }
```

In Table 9 and Table 10, the transmission of the reference line index of the luma channel follows the structure of a conventional VVC. Additionally, in the examples of Table 9 and Table 10, if intra luma_ref_idx and intra_chroma_ref_idx are different, the reference line information of the chroma block is signaled according to Example 1-1.

### <Example 2> Deriving One Reference Line Out of Multiple Reference Lines

In this example, the video encoding device, when predicting the current chroma block according to the IPM, derives information on a reference line to be used for prediction among multiple reference lines. This may be accomplished by (Example 2-1) using a predetermined reference line, (Example 2-2) deriving a reference line based on information from the current chroma block, or (Example 2-3) inheriting a reference line of a representative luma block.

### <Example 2-1> Using a Predefined Reference Line

In this example, the video encoding device performs intra prediction of a chroma block by using a predefined reference line among multiple reference lines regardless of the information on the block. Here, the information on the block may include a size, an aspect ratio, a prediction mode of the chroma block, and the like. The value of the reference line index indicating the predefined reference line may be signaled at a higher level, such as the SPS. Alternatively, by fixating the reference line index that indicates the predetermined reference line to a single value, the present disclosure can obviate the need for signaling the reference line information for the chroma block at the CU level.

### <Example 2-2> Deriving Reference Line Based on Information from Current Chroma Block

In this example, the video encoding device derives a reference line of multiple reference lines based on information of the current chroma block. As one example of the block information, this example may take the distance from the reference line to the side of the block facing the reference line. For example, the height of the block is selected as the block information with the vertical modes No. 50 and above that use the top reference line for prediction, and the width of the block is selected as the block information with prediction modes No. 18 and below that use the left reference line for prediction. With prediction modes greater than the horizontal mode 18 which uses both the top and left reference lines for prediction and less than the vertical mode 50, the larger of the width of the block and the height of the block may be selected as the block information. The video encoding device determines the reference line based on the width or height selected for the chroma block. To improve prediction accuracy, the larger the width or height of the block, the closer the reference line that may be used, as shown in Table 11.

TABLE 11

| Block Size | Reference Line Index |
|---|---|
| (Width or Height) | Used for Prediction |
| 4 | intra_chroma_ref_idx 3 |
| 8 or 16 | intra_chroma_ref_idx 2 |
| 32 or 64 | intra_chroma_ref_idx 1 |
| . | . |
| . | . |
| . | . |

Additionally, the smaller the width or height of the block, the more distant the reference line that may be used.

As another example, the video encoding device may determine which reference line to use for prediction by referencing at least one of the width, the prediction mode, and the aspect ratio of the block. In addition, one or more of the location of the block, pixel values of all or some of the available reference lines, any predictors that can be generated, and a distance between the block and an available reference line may be referenced. Further, the reference line of the current chroma block may be determined by referring to information from a neighboring chroma block or a representative luma block, such as the block's width, height, area, aspect ratio, prediction mode, position, pixel values of all or some of the available reference lines, any predictors that can be generated, the distance between the available reference lines and the block, the reconstructed pixel values of the block, the index of the reference line used, the pixel values of the reference line used, the distance between the reference line used and the corresponding block, and the like. In this case, the representative luma block is defined the same as in Example 1-2.

As an example, the width and height of the current chroma block, the width and height of the neighboring chroma block, and the reference line of the neighboring chroma block may be referenced. Namely, if the current chroma block and the neighboring chroma block have the same width and height, the reference line index of the neighboring chroma block may be used as the reference line index of the current chroma block.

### <Example 2-3> Inheriting the Reference Line of a Representative Luma Block

In this example, the video encoding device inherits the reference line of the representative luma block for the current chroma block to use the same reference line as the reference line of the luma channel. The current chroma block may be predicted by using the reference line having the same index as the reference line index of the inherited representative luma block. In this case, the representative luma block is defined the same as in Example 1-2. For the current chroma block, the video encoding device may use a method of (Example 2-3-1) inheriting the reference line of the representative luma block unconditionally, (Example 2-3-2) inheriting the reference line under certain conditions by referring to information of the block, or (Example 2-3-3) signaling whether to inherit the reference line. In this case, if the luma channel and the chroma channel have different spatial resolutions, such as in a 4:2:0 or 4:2:2 color format, the video encoding device may adjust the reference line index as shown in Equation 4 or Equation 5 to match the positions of the reference lines in the two channels.

intra_chroma_ref_idx=intra_luma_ref_idx»1 [Equation 4]

intra_chroma_ref_idx=(intra_luma_ref_idx+1)»1 [Equation 5]

### <Example 2-3-1> Unconditional Inheritance of the Reference Line Index of the Representative Luma Block

In this example, the video encoding device inherits the reference line index of the representative luma block to derive the reference line index of the current chroma block. For example, if the representative luma block uses intra_luma_ref_idx 1 as the reference line, the current chroma block also uses intra_chroma_ref_idx 1 as the reference line.

### <Example 2-3-2> Inheriting Reference Line Index of Representative Luma Block Under Certain Conditions

In this example, the video encoding device adaptively inherits the reference line index of the representative luma block according to certain conditions by referring to the information of the block. This example may reference one or more of the information items of the current chroma block, the representative luma block, and the neighboring chroma block. The information items of the current chroma block and the representative luma block include width, height, area, aspect ratio, position, intra-prediction mode, pixel values of all or some of the available reference lines, any predictors that can be generated, the distance between the available reference lines and the corresponding block, whether the representative luma block is MRL enabled (i.e., whether the adjacent reference line is to be used), the reference lines of the representative luma block and the pixel values of the corresponding reference lines, the reconstructed pixel values of the representative luma block, and the distance between the representative luma block and the reference line used for the representative luma block. The information items of the neighboring chroma block include whether the neighboring chroma block inherits the reference line, the reference line of the neighboring chroma block, the neighboring chroma block's width, height, area, aspect ratio, position, prediction mode, pixel values of all or some of the available reference lines, any predictors that can be generated, distance between the available reference lines and the corresponding block, the reconstructed pixel values of the block, pixel values of the reference line used, and the like.

For example, an aspect ratio may be referenced for the current chroma block and the representative luma block. For example, if the aspect ratios of the two blocks match, the video encoding device may use the reference line index of the representative luma block as the reference line index of the current chroma block.

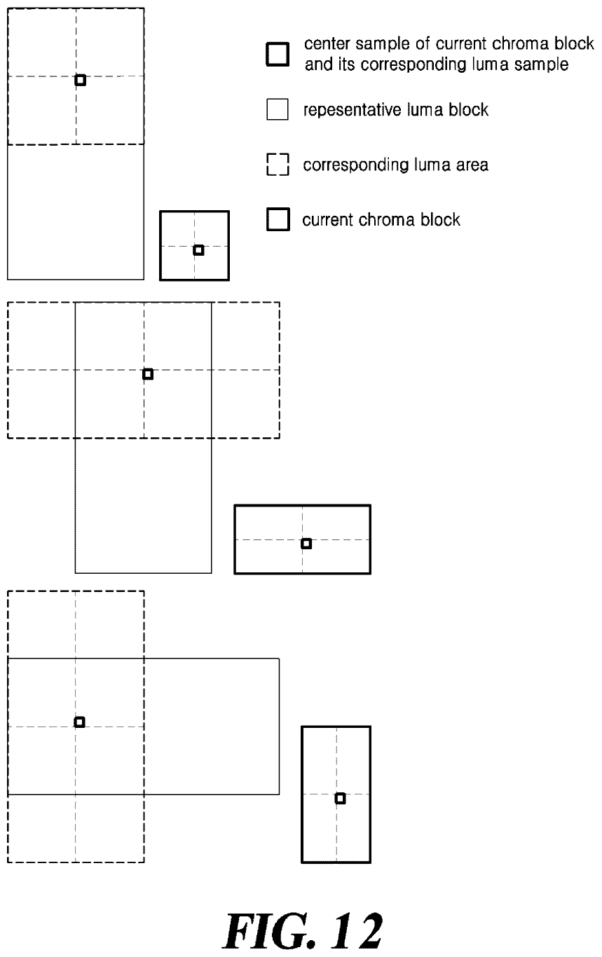

Alternatively, the positions and intra-prediction modes of the current chroma block and the representative luma block may be referenced. If the reference lines used for the prediction of the two blocks are at the same position, the current chroma block inherits the reference line of the representative luma block. In this case, if there is an overlap of at least one of the top or left boundary of the corresponding luma region and the top or left boundary of the representative luma block, the video encoding device determines that the reference line of the representative luma block is at the same location as the current chroma block. For example, the same position may be represented as described above for a 4:2:0 color format, as shown in the example of FIG. 12. As a further condition, if the intra-prediction modes of the two blocks are the same for the current chroma block and the representative luma block (i.e., DM is used as the prediction mode of the chroma block), the video encoding device may inherit the reference line of the representative luma block. As a specific example, the chroma block may inherit the reference line of the representative luma block if, with reference to the positions of the current chroma block and the representative luma block and the intra-prediction mode indicated by the DM, the reference lines used for prediction of the two blocks are at the same position.

Alternatively, the intra-prediction mode of the current chroma block and the representative luma block, and whether the representative luma block uses MRLs, may be referenced. If the prediction modes of the two blocks are the same (i.e., DM is used as the prediction mode of the chroma block), and the representative luma block uses MRLs but does not use the adjacent reference line, the current chroma block may inherit the reference line of the representative luma block. Alternatively, if the prediction modes of the two blocks are the same (i.e. DM is used as the prediction mode of the chroma block) and the representative luma block uses single or multiple preset reference lines (for example, uses intra_luma_ref_idx 2), the chroma block may inherit the reference line of the representative luma block. Alternatively, the aspect ratio of the neighboring chroma block, the aspect ratio of the current chroma block, and whether the neighboring chroma block inherits the reference line may be referenced. For example, if the aspect ratio of the neighboring chroma block and the current chroma block is the same and the neighboring chroma block inherits the reference line of the representative luma block, then the current chroma block may also inherit the reference line of the representative luma block.

If certain conditions based on the block information are not met, the video encoding device may determine a reference line of the chroma block in accordance with the prior art or any of the foregoing examples. As an example, the video encoding device may use the adjacent reference line without considering multiple reference lines or may signal the reference line according to Example 1. Further, the video encoding device may (Example 2-1) use a predefined reference line or (Example 2-2) derive a reference line based on information of the chroma block.

### <Example 2-3-3> Signal Whether or not to Inherit the Reference Line Index of the Representative Luma Block

In this example, the video encoding device signals whether to inherit the reference line index of the representative luma block. For this purpose, the intra_ref_inherit_flag may be signaled. If this value is 1, the video encoding device uses the reference line index of the representative luma block as the reference line index of the chroma block. If this value is 0, the video encoding device may use one of the methods of Example 1 or Example 2 to determine the reference line index of the current chroma block, without inheriting the reference line index of the representative luma block.

### <Example 3> Selectively Combining Existing Technology and Foregoing Examples

In this example, the video encoding device selectively combines the prior art with the foregoing examples to determine the reference line of the chroma channel. In this context, combining may have two meanings. As a first method, the video encoding device may combine all or some of the proposed methods in any order to determine the reference line of the chroma channel. For example, Example 2-3-2 and Example 2-3-3 may be combined. The video encoding device may refer to the information of the block to signal whether to inherit the reference line if certain conditions are met. In this case, if the specific conditions are not met, the reference line for the chroma channel may be determined according to Example 2-3-2. As another example, the video encoding device may inherit the reference line of the luma representation block if certain conditions are met by referring to the information of the block. If certain conditions are not met, the video encoding device may signal whether or not to inherit the reference line.

As a second method, the video encoding device may consider all or some of the proposed methods for one chroma block simultaneously (i.e., at the same level) and select one method. In doing so, the video encoding device may select one method by relying on a signal, as in Example 3, or may select one method by relying on the information of the block without a signal.

When the reference line of the chroma channel is determined by reference to the information of the block, the video encoding device divides the number of cases of all possible block information into n (n>1) groups and uses a specific reference line determination method for each group. For example, if the block information refers to the width of the chroma block and n is 2, the video encoding device may not perform (Example 2-2) the derivation of the reference line based on the information of the chroma block for all cases of the block width. For example, the video encoding device may derive the reference line based on the information of the chroma block for some cases (e.g., derive the reference line if the block width is 16) and signal the reference line (Example 1) for the remaining cases. Alternatively, for the remaining cases, the reference line of the chroma block may be determined by (Example 2-1) using a predefined reference line, (Example 2-3) inheriting the reference line of the representative luma block, or (the first method in Example 3) a combination of these methods.

When signaling one of the multiple reference line determination methods as described above or selecting a reference line of the chroma block without signaling, Example 2-2 of deriving a reference line based on information from the current chroma block is performed with the reference lines of the neighboring chroma blocks also being referenced as information of the block. For example, if the reference line index of a neighboring chroma block is determined to be 2 based on the signaling or deriving method, the reference line index of the current chroma block may be determined to be 2 by referring to the relevant information. Further, all chroma blocks in the video may refer to the reference line information of the neighboring chroma block as the information of the block, and the reference line of the corresponding chroma block may be derived.

### <Example 4> Selective Use of Existing Technology and Foregoing Examples

In this example, the video encoding device signals additional information to selectively apply the methods of Examples 1 to 3 as described above. To this end, the chroma_mrl_flag may be signaled. For example, as shown in Table 12, the video encoding device may be responsive to when the chroma_mrl_flag is 0 for predicting the chroma channel by using only one neighboring reference line in accordance with conventional techniques and not in accordance with the present disclosure. Additionally, when chroma_mrl_flag is 1, Example 2 may be used.

TABLE 12

| | | |
|---|---|---|
| chroma_mrl_flag | 0 | Using existing technology |
| | 1 | Determine reference line by Example 2 |

As another example, as shown in Table 13, the video encoding device may selectively use the prior art and any of the methods of Examples 1 to 3 by additionally signaling chroma_mrl_idx when chroma_mrl_flag is 1.

TABLE 13

| chroma_mrl_flag | 0 | Using existing technology | | |
|---|---|---|---|---|
| | 1 | chroma_mrl_idx | 0 | Determine reference |
| | | | | line by Example 1 |
| | | | 1 | Determine reference |
| | | | | line by Example 2 |
| | | | 2 | Determine reference |
| | | | | line by Example 3 |

### III. When the Prediction Mode of the Current Chroma Block is CCLM

The following examples are described about the video encoding device but may be equally applicable to the video decoding device.

If the prediction mode of the current chroma block is CCLM, coding efficiency may be improved by considering the characteristics of CCLM for how to use multiple reference lines. In the process of predicting the current chroma block, CCLM generates a linear relation between channels by using neighboring reference pixels around the chroma block and neighboring reference pixels around the corresponding luma region. In the present disclosure, the video encoding device selects one of the multiple reference lines rather than a single fixed reference line, and selects, from the selected reference line, reference pixels used in the linear relation between channels of the CCLM. The reference pixels used for the linear relation between the channels include chroma reference pixels and luma reference pixels, collectively referred to as CCLM reference pixels.

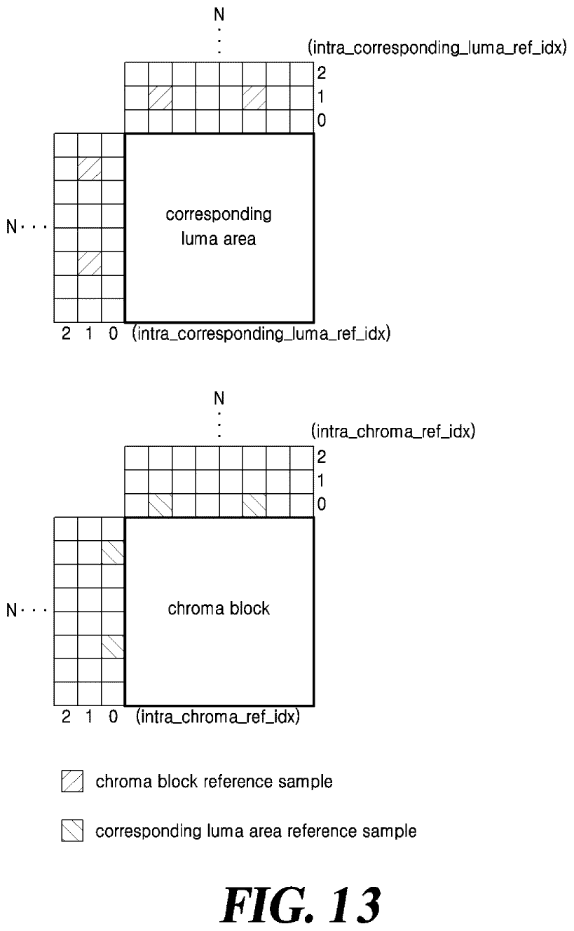

The video encoding device may separately determine a reference line for selecting the CCLM reference pixels for the chroma channel, i.e., the current chroma block and the luma channel, i.e., the corresponding luma region. Thus, the (Example 1) method of selecting one of the multiple reference lines in the chroma channel and the (Example 2) method of selecting one of the multiple reference lines in the luma channel may be combined. As shown in the example of FIG. 13, the reference line indices at which the CCLM reference pixels are located may be different for each channel.

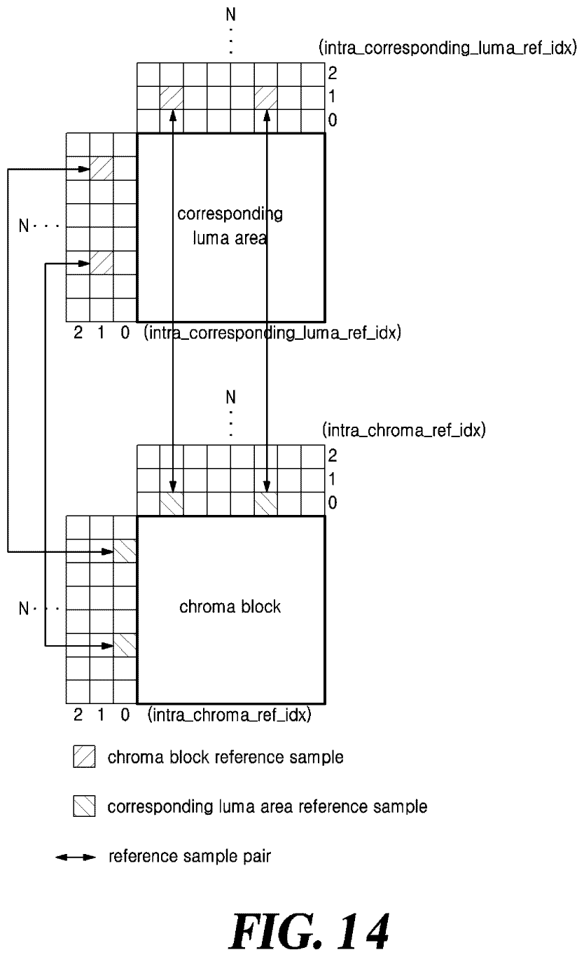

In the following examples, the positions at which the reference pixels are selected per channel establish a correspondence, as shown in the example of FIG. 13. Wherein the positions of selection are relative to the current block, meaning the y coordinate of the reference pixels with the left reference line, and meaning the x coordinate of the reference pixels with the top reference line. However, the positions may not necessarily establish a correspondence. For example, as shown in the example of FIG. 14, the positions at which the reference pixels are selected in the reference lines of each channel may not establish a correspondence. In this case, the pairs of luma reference pixels and chroma reference pixels used to generate the linear relation may be organized in a clockwise order starting from the bottom left corner as shown in the example of FIG. 14 based on the positions of the reference pixels. Alternatively, the pairs described above may be organized according to any convention.

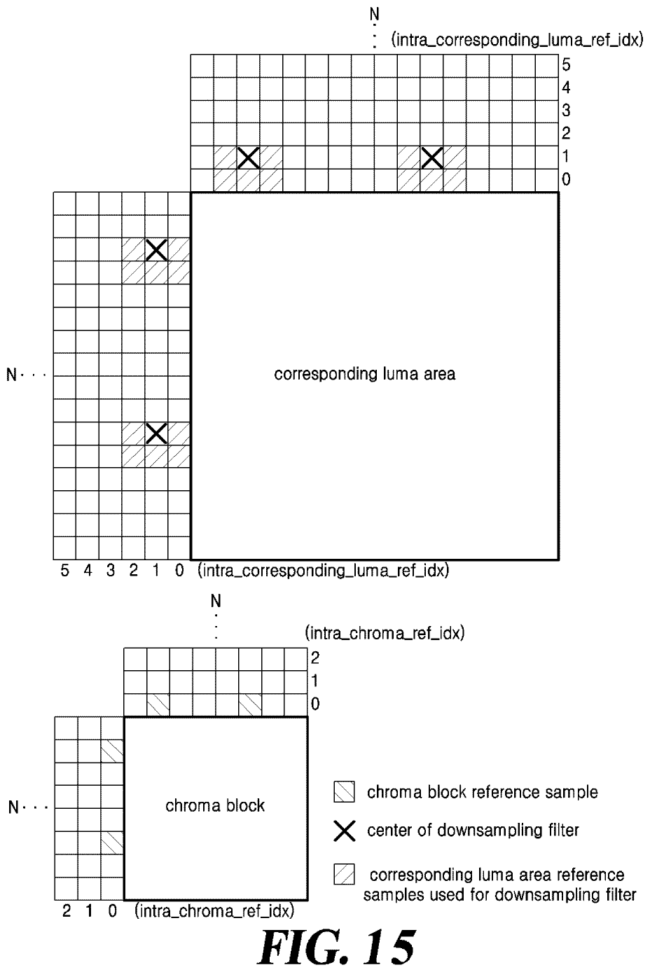

When the picture size of the luma channel is different from that of the chroma channel (i.e., not in a 4:4:4 color format), the CCLM technique applies a downsampling filter to the luma channel to generate a corresponding luma region based on the color format of the input image, as shown in the example of FIG. 7. The following description assumes that the illustration of CCLM reference pixels in the luma channel uses a 2×3 downsampling filter (sps_chroma_vertical_collocated_flag=0), which is the default setting for images in 4:2:0 color format. In this case, the reference line index used to select the reference pixels in the luma channel may represent the reference line index holding the center of the downsampling filter. In the example of FIG. 15, the center of the downsampling filter is located on a reference line one pixel away from the corresponding luma region, so intra_corresponding_luma_ref_idx 1 may be signaled to determine the reference line of the corresponding luma region during the CCLM prediction process.

Furthermore, the chroma pixels that are mapped may vary depending on the phase of the downsampling filter. In contrast, to the 4:4:4 color format, no downsampling is applied, and therefore the reference line index where the selected luma reference pixels are located may be signaled. For example, in the example of FIG. 13 or FIG. 14, intra_corresponding_luma_ref_idx 1 may be signaled.

### <Example 1> Selecting One of the Multiple Reference Lines for the Chroma Channel

In this example, the video encoding device selects one of the multiple reference lines for the chroma channel to select the chroma reference pixels used for the linear relation between the channels when the current chroma block is predicted with CCLM. For this purpose, the (Example 1-1) method of signaling one of the multiple reference lines for the chroma channel or the (Example 1-2) method of deriving one of the multiple reference lines for the chroma channel may be utilized.

### <Example 1-1> Signaling One of the Multiple Reference Lines for the Chroma Channel

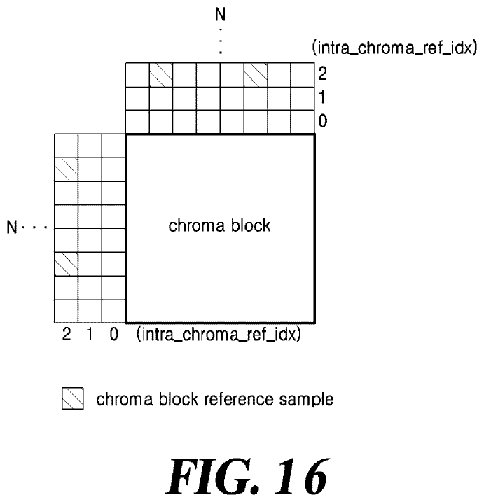

In this example, the video encoding device signals intra_chroma_ref_idx indicating a reference line along which the reference pixels are located for the chroma channel. For example, as shown in the example of FIG. 16, the video encoding device may select CCLM reference pixels for a chroma block from a reference line that is not immediately adjacent to the boundary of the current chroma block but is two pixels away. In this case, intra_chroma_ref_idx may be signaled as 2.

The following syntax elements are required for this example. These elements may be parsed when parsing information related to the CCLM.

intra_chroma_ref_idx indicates a reference line index indicating the reference line containing the CCLM reference pixels in the chroma block and may have a value equal to or greater than 0. If intra_chroma_ref_idx is not present, intra_chroma_ref_idx may be inferred to be 0.

Specific pseudocode according to this example may be realized as follows.

```
If (CCLM available) {
  Parsing CCLM-related signal (cclm_mode_flag)
  if (prediction mode is one of CCLM) {
    Parsing CCLM-related signal (cclm_mode_idx)
    Parsing chroma reference line index
    (intra_chroma_ref_idx)
    Parsing luma reference line index
    (intra_corresponding_luma_ref_idx)
  }
}
```

When the (Example 1-2) method of deriving one of the multiple reference lines for a chroma channel is used, parsing the reference line index of the chroma channel is omitted. Similarly, when the (Example 2-2) method of deriving one of the multiple reference lines for the luma channel is used, parsing the reference line index of the luma channel may be omitted. If reference lines are signaled for both channels, either the reference line index of the chroma channel, intra_chroma_ref_idx, or the reference line index of the luma channel, intra_corresponding_luma_ref_idx, may be parsed first.

Based on the pseudocode described above, the required syntax for transmission is shown in Table 14.

TABLE 14

```
  if( CclmEnabled )
    cclm_mode_flag
  if( cclm_mode_flag ) {
    cclm_mode_idx
intra_chroma_ref_idx
intra_corresponding_luma_ref_idx
  } else
intra_chroma_pred_mode
```

### <Example 1-2> Deriving One of the Multiple Reference Lines for the Chroma Channel

In this example, the video encoding device derives a reference line along which the CCLM reference pixels are located for the chroma channel. To do so, the video encoding device may (Example 1-2-1) use a predetermined reference line, (Example 1-2-2) derive the reference line based on information of the current chroma block, or (Example 1-2-3) inherit the reference line of the corresponding luma region.

### <Example 1-2-1> Using a Predefined Reference Line

In this example, the video encoding device selects a predefined reference line among multiple reference lines regardless of block information, and then selects, from the reference line, CCLM reference pixels of the chroma block used for the linear relation of CCLM. At this time, the value of the reference line index indicating the predefined reference line may be signaled at a higher level such as SPS. Alternatively, the reference line index indicating the predetermined reference line may be fixed to a single value, such that the reference line information may not be signaled for the chroma block at the CU level.

### <Example 1-2-2> Deriving a Reference Line Based on Information of the Current Chroma Block

In this example, the video encoding device derives a reference line of one of multiple reference lines based on information of the current chroma block and selects CCLM reference pixels of the chroma block used for linear relation of CCLM from the derived reference line. As an example of the block information, the distance from the reference line to the sides of the facing a block may be considered. The height of the block is considered for CCLM_T which selects the top reference pixels, and the width of the block is selected for CCLM_L which selects the left reference pixels. The larger of the width and height may be selected for CCLM_LT which uses both the top and left reference pixels for prediction. Depending on the width or height selected for the chroma block, the video encoding device determines which reference line to select the reference pixels of the chroma block used for the linear relation. To improve the prediction accuracy, the larger the value of the width or height of the block, the closer the reference line that may be used, as shown in Table 11.

TABLE 15

| Block Size | Reference Line Index Used |
|---|---|
| (Width or Height) | for Selectin Reference Pixels |
| 2 or 4 | intra_chroma_ref_idx 3 |
| 8 or 16 | intra_chroma_ref_idx 2 |
| 32 or 64 | intra_chroma_ref_idx 1 |
| . | . |
| . | . |
| . | . |

Additionally, the smaller the width or height of the block, the more distant the reference line may be used.

As another example, the video encoding device may determine which reference line to use for prediction by referencing at least one of the block's width, prediction mode, and aspect ratio. In addition, the video encoding device may reference one or more of the block's location, pixel values of all or some of the available reference lines, any predictors that can be generated, and a distance between the block and the available reference lines. Further, as information of the neighboring chroma block to be referenced for determining the reference line of the current chroma block, the following items may be provided: the neighboring chroma block's width, height, area, aspect ratio, prediction mode, position, pixel values of all or some of the available reference lines, any predictors that can be generated, the distance between the available reference lines and the block, the reconstructed pixel values of the block, the index of the reference line used, the pixel values of the reference line used, the distance between the reference line used and the corresponding block, and the like.

In one example, the width and height of the current chroma block, the width and height of the neighboring chroma block, and the reference line of the neighboring chroma block may be referenced. If the width and height of the current chroma block and the neighboring chroma block are the same, the reference line index of the neighboring chroma block may be used as the reference line index of the current chroma block.

### <Example 1-2-3> Inheriting the Reference Line of the Corresponding Luma Region

In this example, the video encoding device inherits one of multiple reference lines from the corresponding luma region of the current chroma block as the reference line information and selects from the inherited reference line the CCLM reference pixels of the chroma block used for the linear relation of the CCLM. Namely, the reference pixels of the chroma block may be selected from the reference line with the same index as the reference line index used for selecting the reference pixels of the corresponding luma region. At this time, the reference line of the corresponding luma region, intra_corresponding_luma_ref_idx, may be adjusted according to the color format of the image. For example, if it is not a 4:4:4 color format, performed is a bitshift of intra_chroma_ref_idx=intra_corresponding_luma_ref_idx»1. When the reference pixels of the chroma block are selected according to this example, the (Example 2-2-2) method of inheriting from the current chroma block cannot be applied when determining the reference line index of the corresponding luma region.

In the application of the present embodiment, the reference line of the corresponding luma region may be (Example 1-2-3-1) inherited unconditionally, (Example 1-2-3-3) signaled for positive or negative inheritance, or (Example 1-2-3-3) inherited under certain conditions by referring to information of the chroma block. These examples may be implemented similarly to Example 2-3 of the foregoing examples where the current prediction mode of the chroma block is IPM.

### <Example 1-2-3-1> Unconditionally Inheriting the Reference Line Index of the Corresponding Luma Region

In this example, the video encoding device inherits the reference line index of the corresponding luma region to derive the reference line index from which the CCLM reference pixels of the current chroma block are selected. For example, for a 4:4:4 color format, if the CCLM reference pixels in the corresponding luma region are selected from the reference line indicated by intra_corresponding_luma_ref_idx 1, then the CCLM reference pixels in the current chroma block are also selected from the reference line indicated by intra_chroma_ref_idx 1.

### <Example 1-2-3-2> Signaling Whether or not to Inherit the Reference Line Index of the Corresponding Luma Region

In this example, the video encoding device signals whether to inherit the reference line index of the corresponding luma region. For this purpose, the intra_ref_inherit_luma flag may be signaled. If this value is 1, the video encoding device uses the reference line index of the corresponding luma region as the reference line index of the chroma block. If this value is 0, the video encoding device may use the method of Example 1-1, 1-2-1, or 1-2-2 to determine the reference line index of the current chroma block without inheriting the reference line index of the corresponding luma region.

### <Example 1-2-3-3> Inheriting Under Certain Conditions by Referring to Information of The Chroma Block

In this example, the video encoding device inherits the reference line index of the corresponding luma region according to certain conditions by referring to the information of the chroma block. This example may reference one or more of the information items of the chroma block and the neighboring chroma block. The information items of the block are the block's width, height, area, aspect ratio, position, CCLM mode index indicating the type of CCLM mode, pixel values of all or some of the available reference lines, any predictors that can be generated, and the distance between the available reference lines and the corresponding block. The information items of the neighboring chroma block include whether the neighboring chroma block inherits the reference line, the reference line of the neighboring chroma block, neighboring chroma block's width, height, area, aspect ratio, position, prediction mode, pixel values of all or some of the available reference lines, any predictors that can be generated, the distance between the available reference lines and the corresponding block, reconstructed pixel values of the block, index and pixel values of the reference lines used, and the like. In one example, if a chroma block has a width of 64 or more, the reference line index of the corresponding luma region may be inherited. As another example, the aspect ratio of the neighboring chroma block, the aspect ratio of the current chroma block, and whether the neighboring chroma block inherits the reference line may be referenced. Namely, if the aspect ratio of the neighboring chroma block and the aspect ratio of the current chroma block are the same and the neighboring chroma block inherits the reference line of the corresponding luma region, the current chroma block may also inherit the reference line of the corresponding luma region.

If the current chroma block satisfies certain conditions, the video encoding device may select the CCLM reference pixels of the chroma block from a reference line determined in accordance with the prior art or any of the foregoing examples.

### <Example 2> Selecting One of the Multiple Reference Lines for the Luma Channel

In this example, the video encoding device selects one of the multiple reference lines for the luma channel to select CCLM reference pixels of the corresponding luma region that are used for a linear relation between the channels when the current chroma block is predicted by CCLM. For this purpose, the (Example 2-1) method of signaling one of the multiple reference lines for the luma channel or the (Example 2-2) method of deriving one of the multiple reference lines for the luma channel may be utilized.

### <Example 2-1> Signaling One of the Multiple Reference Lines on the Luma Channel

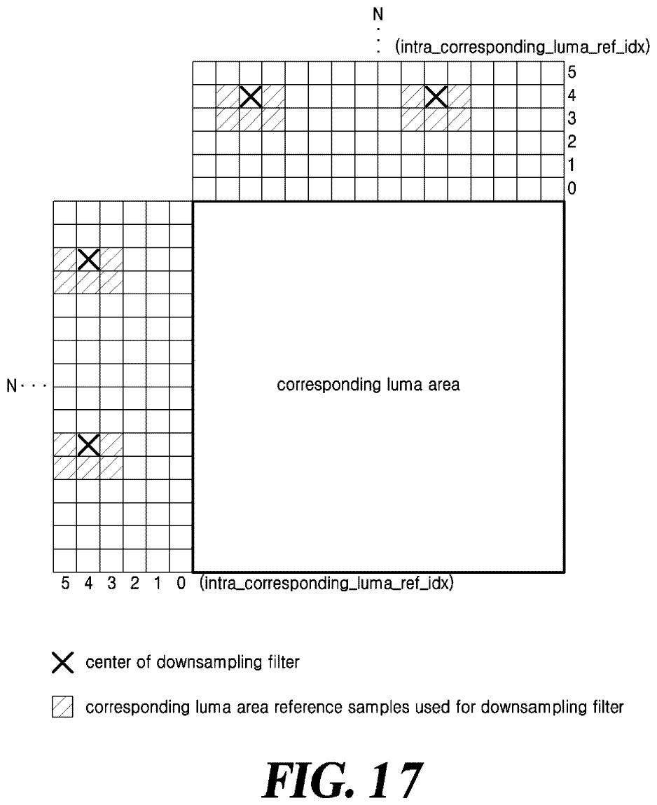

In this example, the video encoding device signals intra_corresponding_luma_ref_idx for the luma channel, indicating the reference line on which the CCLM reference pixels are located. As an example, for a 4:2:0 color format, as illustrated in FIG. 17, the video encoding device may select CCLM reference pixels for the corresponding luma region from a reference line that is four pixels away from, but not immediately adjacent to, the boundary of the corresponding luma region. In this case, the center of the downsampling filter is located on that reference line, and the intra_corresponding_luma_ref_idx indicating that the reference line may be signaled as 4.

The following syntax elements are required for this example. When information related to the CCLM is parsed, these elements may be parsed.

intra_corresponding_luma_ref_idx represents a reference line index that indicates the reference line used to select the CCLM reference pixels in the corresponding luma region. This index may have a value of 0 or higher for the 4:4:4 color format, and the values that may exist for the rest of the formats depend on the shape of the filter applied to the downsampling. For example, when the filter illustrated in FIG. 17 is applied, this index may have a value of 1 or more. If intra_corresponding_luma_ref_idx does not exist, intra_corresponding_luma_ref_idx may be inferred to be 0 for the 4:4:4 color format. For the remaining formats, a value of this index (1 for the filter illustrated in FIG. 17) may be inferred so that the downsampling filter is applied to locations adjacent to the corresponding luma region.

The specific pseudocode for this example may be realized as follows. This is the same as the techniques in Example 1-1.

```
If (CCLM available) {
  Parsing CCLM-related signal (cclm_mode_flag)
  if (prediction mode is one of CCLM) {
    Parsing CCLM-related signal (cclm_mode_idx)
    Parsing chroma reference line index
    (intra_chroma_ref_idx)
    Parsing luma reference line index
    (intra_corresponding_luma_ref_idx)
  }
}
```

When using the (Example 1-2) method of deriving one of the multiple reference lines for a chroma channel, parsing the reference line index of the chroma channel is omitted. Similarly, when using the (Example 2-2) method of deriving one of the multiple reference lines for the luma channel, parsing the reference line index of the luma channel may be omitted. If reference lines are signaled for both channels, either the reference line index for the chroma channel, intra_chroma_ref_idx, or the reference line index for the luma channel, intra_corresponding_luma_ref_idx, may be parsed first.

Based on the pseudocode described above, the required syntax for transmission is shown in Table 16.

TABLE 16

```
  if( CclmEnabled )
    cclm_mode_flag
  if( cclm_mode_flag ) {
    cclm_mode_idx
intra_chroma_ref_idx
intra_corresponding_luma_ref_idx
  } else
intra_chroma_pred_mode
```

### <Example 2-2> Derivation of One of the Multiple Reference Lines for the Luma Channel

In this example, the video encoding device derives a reference line along which the CCLM reference pixels are located for the luma channel. This may be accomplished by (Example 2-2-1) using a predetermined reference line, (Example 2-2-2) inheriting the reference line of the current chroma block, or (Example 2-2-3) inheriting the MRL index of the luma block.

### <Example 2-2-1> Using a Predefined Reference Line

In this example, the video encoding device selects a predefined reference line among multiple reference lines regardless of the information of the block, and then selects, from the reference line, CCLM reference pixels of the corresponding luma region used for the linear relation of CCLM. At this time, the value of the reference line index indicating the predefined reference line may be signaled at a higher level such as SPS. Alternatively, by fixating the reference line index indicating the predetermined reference line to a single value, the information of the reference line may not be signaled for the chroma block at the CU level.

### <Example 2-2-2> Inheriting the Reference Line of the Current Chroma Block

In the present example, the video encoding device inherits one of the multiple reference lines from the current chroma block as the reference line information, and selects, from the inherited reference line, CCLM reference pixels of the corresponding luma region used for the linear relation of CCLM. Namely, the reference pixels of the corresponding luma region may be selected from the reference line with the same index as the reference line index used for selecting the reference pixels of the chroma block. At this time, the reference line of the chroma block, intra_chroma_ref_idx, may be adjusted according to the color format of the image. For example, if it is not a 4:4:4 color format, performed is a bit shift of intra_corresponding_luma_ref_idx=intra_chroma_ref_idx<<1). When the reference pixels of the corresponding luma region are selected according to this example, the (Example 1-2-3) method of inheriting from the corresponding luma region cannot be applied when deriving the reference line index of the current chroma block.

In the application of this embodiment, the reference line of the current chroma block may be (Example 2-2-2-1) inherited unconditionally, (Example 2-2-2-2) signaled for inheritance, or (Example 2-2-2-3) inherited under certain conditions by referring to information of the chroma block. These examples, like Example 1-2-3, may be implemented similarly to Example 2-3 in the case where the current prediction mode of the chroma block is IPM among the foregoing examples.

### <Example 2-2-2-1> Unconditional Inheritance of Reference Line Indexes of Chroma Blocks

In this example, the video encoding device inherits the reference line index of the chroma block to derive the reference line index from which the CCLM reference pixels in the corresponding luma region are selected. For example, for a 4:4:4 color format, if the CCLM reference pixels in the chroma block are selected from the reference line indicated by intra_chroma_ref_idx 1, then the CCLM reference pixels in the corresponding luma region are also selected from the reference line indicated by intra_corresponding_luma_ref_idx 1.

### <Example 2-2-2-2> Signaling Whether or not to Inherit the Reference Line Index of the Chroma Block

In this example, the video encoding device signals whether to inherit the reference line index of the chroma block. For this purpose, the intra_ref_inherit_chroma_flag may be signaled. If this value is 1, the video encoding device uses the reference line index of the chroma block as the reference line index of the corresponding luma region. If this value is 0, the video encoding device may not inherit the reference line index of the chroma block and may use the method of Example 2-1 or 2-2-1 to determine the reference line index of the corresponding luma region.

### <Example 2-2-2-3> Inheriting Under Certain Conditions by Referring to Information of The Chroma Block

In this example, the video encoding device references information of a chroma block to inherit a reference line index of the chroma block under certain conditions. The information of the corresponding luma region may be referenced, but since the corresponding luma region is defined according to the chroma block, using the information of the corresponding luma region has the same effect as using the information of the chroma block. This example may reference, as information on the block, one or more of width, height, area, aspect ratio, position, and CCLM mode index indicating the type of CCLM mode, pixel values of all or some of the available reference lines, any predictors that can be generated, and the distance between the available reference lines and the relevant block. In addition, reconstructed pixel values within the corresponding luma region, the neighboring reference pixels around the corresponding luma region, and the like may be referenced. For example, the reference line index of the chroma block may be inherited if the chroma block has a width of 64 or more. In addition, referenced as information of the block may be whether the luma region corresponding to the neighboring chroma block (i.e., the neighboring region of the current corresponding luma region) inherits the reference line, or the reference line of the luma region corresponding to the neighboring chroma block.

If the current chroma block does not satisfy certain conditions, the video encoding device may select CCLM reference pixels of the corresponding luma region from a reference line determined in accordance with the prior art or any of the foregoing examples.

### <Example 2-2-3> Inheriting MRL Index of Luma Block

In this example, the video encoding device inherits intra_luma_ref_idx, an index indicating a reference line of the luma channel according to the MRL technique, to determine a reference line of the corresponding luma region, and selects CCLM reference pixels of the corresponding luma region from the determined reference line. Since the reference line selected by the MRL technique for the luma channel is the most appropriate reference line for the prediction of the corresponding luma block, inheriting this information is advantageous in that it can reduce the signaling cost. At this time, the video encoding device may inherit the MRL index of the luma block that matches the corresponding luma region in size, shape, and position. As with Example 2-2-2, the reference line of the luma block may be (Example 2-2-3-1) inherited unconditionally or (Example 2-2-3-2) signaled for inheritance.

### <Example 2-2-3-1> Unconditional Inheritance of the MRL Index of a Luma Block

In the example, the video encoding device inherits the reference line index of a luma block that has the same size, shape, and position as the corresponding luma region. At this time, the reference line of the corresponding luma block may be determined by parsing the intra luma_ref_idx during encoding/decoding of the luma channel according to the syntax parsing method of the MRL technology. For example, if a luma block that matches the size, shape, and position of the corresponding luma region exists and the reference line of the block is indicated by intra_luma_ref_idx 2, then the CCLM reference pixels of the corresponding luma region are also selected from the reference line indicated by intra_corresponding_luma ref_idx 2.

### <Example 2-2-3-2> Signaling Whether or not to Inherit the MRL Index of the Luma Block

In the example, the video encoding device signals whether to inherit the MRL index of the luma block. For this purpose, the intra_ref_inherit_chroma_flag may be signaled. If this value is 1, the video encoding device uses the MRL index (i.e., intra_luma_ref_idx) of the luma block that has the same size, shape, and position as the corresponding luma region as the reference line index of the corresponding luma region. If this value is 0, the video encoding device may use the method of Example 2-1, 2-2-1, or 2-2-2 to determine the reference line index of the corresponding luma region without inheriting the MRL index of the luma block that has the same size, shape, and position as the corresponding luma region. If no luma block exists that has the same size, shape, and position as the corresponding luma region, the intra_ref_inherit_chroma_flag may be inferred to be 0.

### <Example 3> Selectively Combining Existing Techniques and the Foregoing Examples

In the example, the video encoding device selectively combines the foregoing examples with prior art to determine reference lines of the chroma channel and luma channel. In this context, combining may have two meanings. As a first method, the video encoding device may combine all or some of the proposed methods in any order to determine the reference lines of the chroma channel and the luma channel. For example, when the reference lines for the chroma channel are determined to select CCLM reference pixels of the chroma block, Example 1-2-3-2 and Example 1-2-3-3 may be combined. The video encoding device may signal whether to inherit the reference line if certain conditions are met by referencing one or more of the block's width, height, area, aspect ratio, position, and a CCLM mode index indicating the type of CCLM mode. In this case, if the specific conditions are not met, the reference line for the chroma channel may be determined according to Example 1-2-3-3. As another example, for combining Example 1-2-3-2 and Example 1-2-3-3, the video encoding device may inherit the reference line if certain conditions are met by referring to the information of the block. At the same time, if certain conditions are not met, the inheritance or non-inheritance of the reference line may be signaled. The reference line of the corresponding luma region may similarly be determined based on a combination of the prior art and the presented examples.

In a second method, the video encoding device may consider all or some of the proposed methods for a chroma block simultaneously (i.e., at the same level) and select one of them. In doing so, the video encoding device may select one method by relying on a signal, as in Example 3, or may select one method by relying on the information of the block without a signal.

In the case of determining by reference to the information of the block, the video encoding device divides the number of cases of all possible block information into n (n>1) groups and uses a specific reference line determination method for each group. In this case, referenced as the information of the block may be at least one of the block's width, height, area, aspect ratio, position, and a CCLM mode index indicating a type of CCLM mode.

As an example, when a chroma block reference line is determined for selecting CCLM reference pixels, if the video encoding device refers to the width of the chroma block as the information of the block and n is 2, the video encoding device may not perform (Example 1-2-2) the derivation of the reference line according to the information of the chroma block for all cases of the width of the block. Namely, the video encoding device may derive the reference line based on the information of the chroma block for some cases (e.g., derive the reference line if the block width is 16) and (Example 1-1) signal the reference line for the remaining cases. Alternatively, the reference line of the chroma block may be determined by (Example 1-2-1) using a predefined reference line for the remaining cases, (Example 1-2-3) inheriting the reference line of the corresponding luma region, or (the first method in Example 3) combination of these methods. The reference line of the corresponding luma region may similarly be determined based on a combination of the prior art and the presented examples.

When selecting the reference lines of a chroma block and corresponding luma region with or without signaling one of the multiple reference line determination methods as described above, Example 1-2-2 of ‘deriving the reference line based on information of the current chroma block’ may be performed with the reference lines of neighboring chroma blocks being also referenced as information of the block. For example, if the reference line index of a neighboring chroma block is determined to be 2 based on the signaling or deriving method, the reference line index of the current chroma block may be determined to be 2 by referring to the relevant information. Further, all chroma blocks in the image may refer to the reference line information of the adjacent chroma block as information of the block, and the reference line of the corresponding chroma block may be derived.

### <Example 4> Selectively Using Existing Technology and the Foregoing Examples

In the present example, the video encoding device signals additional information to selectively apply the methods of Examples 1 to 3 as described above. For this purpose, a cclm_mrl_flag may be signaled. In one example, as shown in Table 17, if this value is 0, the video encoding device may predict the chroma channel according to a conventional CCLM technique method, overriding the present disclosure. If this value is 1, to use multiple reference lines per channel, the video encoding device may apply Example 1-1 to the chroma channel and Example 2-1 to the luma channel, allowing to use a method of signaling reference lines for both channels.

TABLE 17

| | | |
|---|---|---|
| cclm_mrl_flag | 0 | Using existing technology |
| | 1 | Determine chroma reference line by Example 1-1 |
| | | & Determine luma reference line by Example 2-1 |

As another example, as shown in Table 18, the video encoding device may selectively use one of the conventional techniques, and the combination methods of Examples 1 and 2, by signaling cclm_mrl_flag and cclm_mrl_idx.

TABLE 18

| cclm_{—} | 0 | Using existing technology | | |
|---|---|---|---|---|
| mrl_flag | 1 | cclm_{—} | 0 | Determine chroma reference |
| | | mrl_idx | | line by Example 1-1 & |
| | | | | Determine luma reference |
| | | | | line by Example 2-1 |
| | | | 1 | Determine chroma reference |
| | | | | line by Example 1-2-1 & |
| | | | | Determine luma reference |
| | | | | line by Example 2-1 |
| | | | . | . |
| | | | . | . |
| | | | . | . |

As yet another example, as shown in Table 19, when cclm_mrl_flag is 1, the video encoding device may use cclm_mrl_chroma_idx and cclm_mrl_luma_idx to signal the implementation method to apply per channel.

TABLE 19

| cclm_{—} | 0 | Using existing technology | | |
|---|---|---|---|---|
| mrl_flag | 1 | cclm_mrl_{—} | 0 | Determine chroma reference |
| | | chroma_idx | | line by Example 1-1 |
| | | | 1 | Determine chroma reference |
| | | | | line by Example 1-2-1 |
| | | | . | . |
| | | | . | . |
| | | | . | . |
| | | cclm_mrl_{—} | 0 | Determine luma reference |
| | | luma_idx | | line by Example 2-1 |
| | | | 1 | Determine luma reference |
| | | | | line by Example 2-2-1 |
| | | | . | . |
| | | | . | . |
| | | | . | . |

### <Example 5> Setting the Corresponding Luma Region by Using Various Downsampling Filters

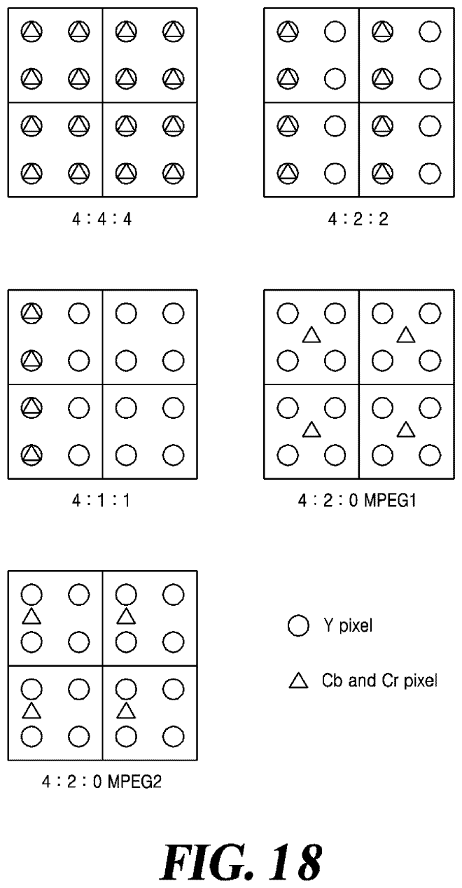

FIG. 18 is a diagram further illustrating downsampling filters according to color formats.

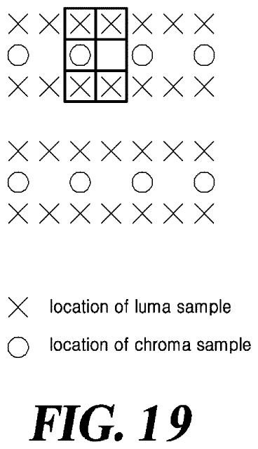

In the example, when the color format is not 4:4:4, the video encoding device may use various downsampling filters, in addition to the methods illustrated in FIG. 7, to make the corresponding luma region equal in size to the current chroma block. For example, as illustrated in FIG. 18, various downsampling filters may be applied. In particular, a filter with a 4:2:0 MPEG2 downsampling scheme is illustrated in FIG. 19. When these various downsampling filters are utilized to set the corresponding luma regions, the video encoding device may commonly apply the MRL in accordance with any of the foregoing Examples 1 to 4.

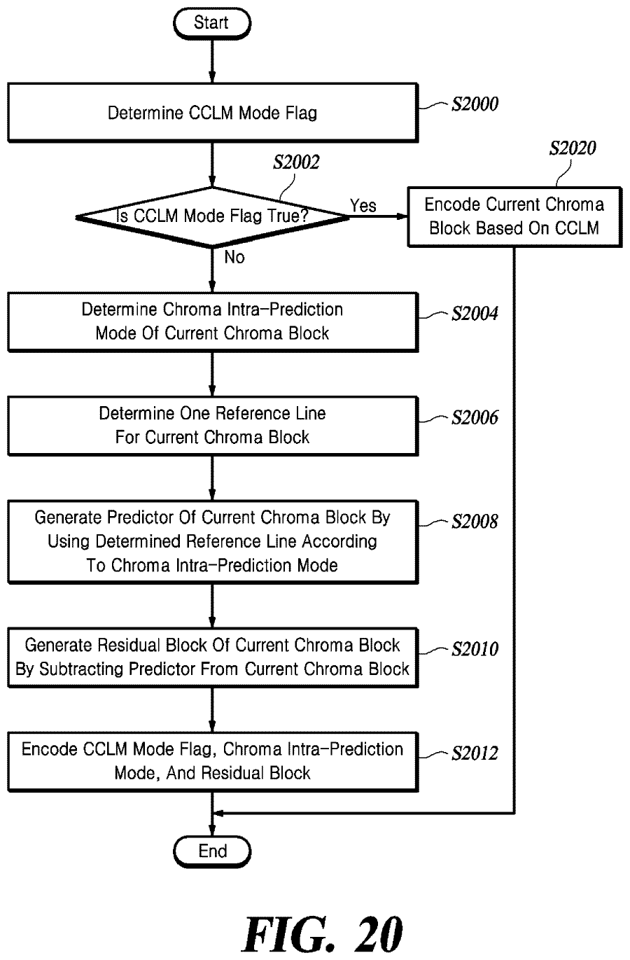

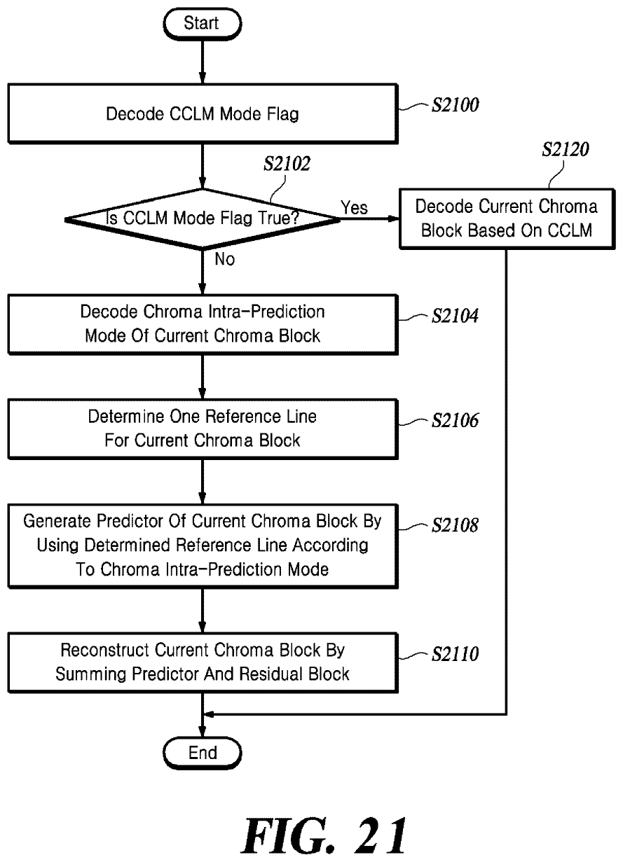

The following describes, with reference to FIGS. 20 and 21, a method for the video encoding device or video decoding device to intra-predict and encode/decode a current chroma block based on IPM.

FIG. 20 is a flowchart of a method performed by the video encoding device for encoding the current chroma block, according to at least one embodiment of the present disclosure.

The video encoding device determines a CCLM mode flag (S2000). Here, the CCLM mode flag indicates whether or not to use CCLM mode. In terms of optimizing coding efficiency, the video encoding device may determine the value of the CCLM mode flag.

The video encoding device checks the CCLM mode flag (S2002).

If the CCLM mode flag is false (No in S2002), the video encoding device may perform the following steps.

The video encoding device determines a chroma intra-prediction mode of the current chroma block (S2004). The video encoding device may determine the chroma intra-prediction mode in terms of optimizing coding efficiency.

Upon determining the chroma intra-prediction mode indicator and the luma intra-prediction mode, the video encoding device may set the chroma intra-prediction mode according to Table 1 based on the chroma intra-prediction mode indicator and the luma intra-prediction mode.

The video encoding device determines a reference line of one of the multiple neighboring chroma pixel lines for the current chroma block based on the multiple neighboring chroma pixel lines of the current chroma block or the multiple neighboring luma pixel lines of a representative luma block (S2006). Here, the representative luma block is a block containing luma pixels corresponding to pixels at a preset position in the current chroma block. Further, the reference line of the current chroma block is indicated by the reference line index of the current chroma block.

The video encoding device may determine the reference line of the current chroma block by using one of the methods of Example 1 to Example 4, corresponding to the case where the prediction mode of the current chroma block is IPM.

The video encoding device generates a predictor of the current chroma block by using the determined reference line according to the chroma intra-prediction mode (S2008).

The video encoding device subtracts the predictor from the current chroma block to generate a residual block of the current chroma block (S2010).

The video encoding device encodes the CCLM mode flag, the chroma intra-prediction mode, and the residual block (S2012).

On the other hand, if the CCLM mode flag is true (Yes in S2002), the video encoding device encodes the current chroma block based on CCLM (S2020).

FIG. 21 is a flowchart of a method performed by the video decoding device for decoding the current chroma block, according to at least one embodiment of the present disclosure.

The video decoding device decodes from the bitstream a residual block of the current chroma block and a CCLM mode flag (S2100). Here, the CCLM mode flag indicates whether CCLM mode is enabled or disabled.

The video decoding device checks the CCLM mode flag (S2102).

If the CCLM mode flag is false (No in S2102), the video decoding device performs the following steps.

The video decoding device decodes the chroma intra-prediction mode of the current chroma block from the bitstream (S2104).

The video decoding device may, after decoding the chroma intra-prediction mode indicator and the luma intra-prediction mode, determine the chroma intra-prediction mode according to Table 1 based on the chroma intra-prediction mode indicator and the luma intra-prediction mode.

The video decoding device determines one reference line of the multiple neighboring chroma pixel lines for the current chroma block based on the multiple neighboring chroma pixel lines of the current chroma block or the multiple neighboring luma pixel lines of the representative luma block (S2106). Here, the representative luma block is a block containing luma pixels corresponding to pixels at a preset position of the current chroma block. Further, the reference line of the current chroma block is indicated by the reference line index of the current chroma block.

The video decoding device may determine the reference line of the current chroma block by using one of the methods of Example 1 to Example 4, corresponding to the case where the prediction mode of the current chroma block is IPM.

The video decoding device generates a predictor of the current chroma block by using the determined reference line according to the chroma intra-prediction mode (S2108).

The video decoding device reconstructs the current chroma block by summing the predictor and the residual block (S2110).

On the other hand, if the CCLM mode flag is true (Yes in S2102), the video decoding device decodes the current chroma block based on CCLM (S2120).

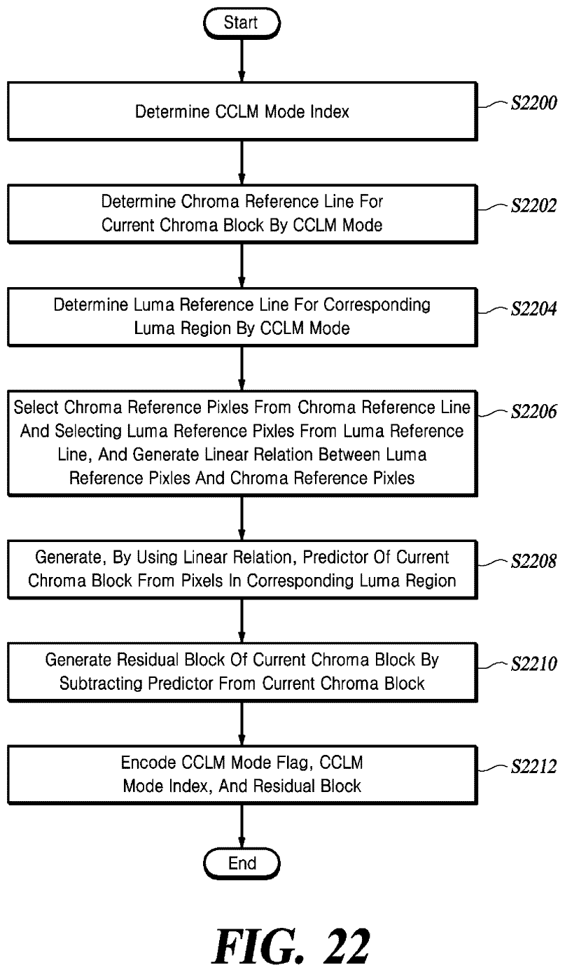

FIG. 22 is a flowchart of a method performed by the video encoding device for encoding the current chroma block, according to another embodiment of the present disclosure.

The following details Step S2020 wherein, if the CCLM mode flag is true (Yes in S2002), the video encoding device encodes the current chroma block based on CCLM.

The video encoding device determines a CCLM mode index (S2200). Here, the CCLM mode index indicates a CCLM mode for the current chroma block. In terms of optimizing coding efficiency, the video encoding device may determine the CCLM mode index. The CCLM modes according to the CCLM mode index are shown in Table 1.

Depending on the CCLM mode, the video encoding device determines one reference line of the multiple neighboring chroma pixel lines for the current chroma block based on the multiple neighboring chroma pixel lines of the current chroma block or the multiple neighboring luma pixel lines of the corresponding luma region (S2202). The corresponding luma region is a region in the luma channel corresponding to the current chroma block. The reference line of the current chroma block is indicated by a reference line index of the current chroma block.

The video encoding device may determine the chroma reference line by using one of the methods of Example 1, Example 3, and Example 4, corresponding to the case where the prediction mode of the current chroma block is CCLM.

Depending on the CCLM mode, the video encoding device determines one reference line of the multiple neighboring luma pixel lines for the corresponding luma region based on the multiple neighboring chroma pixel lines of the current chroma block or the multiple neighboring luma pixel lines of the corresponding luma region (S2204). Here, the reference line of the corresponding luma region is indicated by a reference line index of the corresponding luma region.

The video encoding device may determine the luma reference line by using one of the methods of Example 2 to Example 4, corresponding to the case where the prediction mode of the current chroma block is CCLM.

The video encoding device selects the chroma reference pixels from the chroma reference line and the luma reference pixels from the luma reference line, and generates a linear relation between the luma reference pixels and the chroma reference pixels (S2206).

The video encoding device uses the linear relation to generate a predictor of the current chroma block from the pixels in the corresponding luma region (S2208).

The video encoding device subtracts the predictor from the current chroma block to generate a residual block of the current chroma block (S2210).

The video encoding device encodes the CCLM mode flag, the CCLM mode index, and the residual block (S2212).

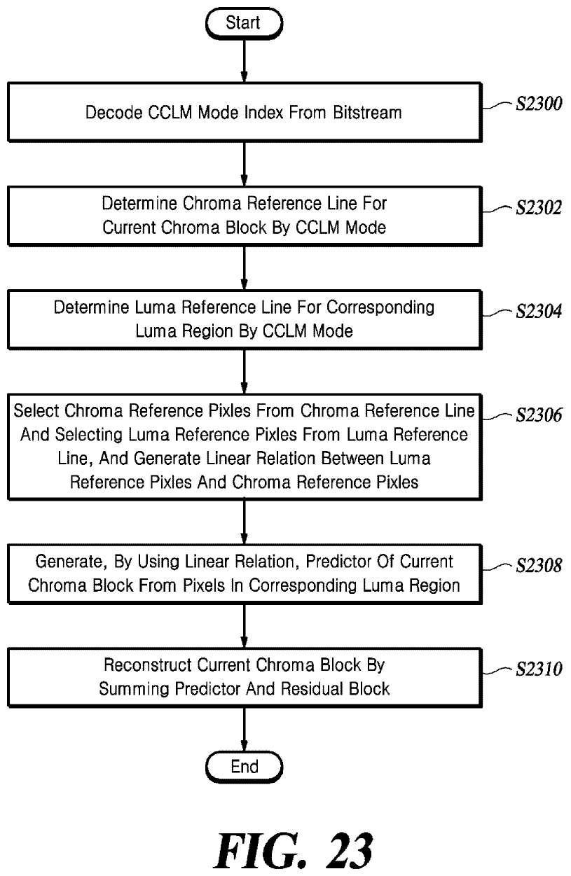

FIG. 23 is a flowchart of a method performed by the video decoding device for decoding the current chroma block, according to another embodiment of the present disclosure.

The following details Step S2120 for the video decoding device to decode the current chroma block based on CCLM when the CCLM mode flag is true (Yes in S2102).

The video decoding device decodes a CCLM mode index from the bitstream (S2300).

Here, the CCLM mode index indicates the CCLM mode of the current chroma block. The CCLM mode according to the CCLM mode index is shown in Table 1.

The video decoding device determines based on the CCLM mode, one reference line of the multiple neighboring chroma pixel lines for the current chroma block based on the multiple neighboring chroma pixel lines of the current chroma block or the multiple neighboring luma pixel lines of the corresponding luma region (S2302). The corresponding luma region is a region in the luma channel corresponding to the current chroma block. The reference line of the current chroma block is indicated by a reference line index of the current chroma block.

The video decoding device may determine the chroma reference line by using one of the methods of Example 1, Example 3, and Example 4, corresponding to the case where the prediction mode of the current chroma block is CCLM.

The video decoding device determines one reference line of the multiple neighboring luma pixel lines for the corresponding luma region based on the multiple neighboring chroma pixel lines of the current chroma block or the multiple neighboring luma pixel lines of the corresponding luma region, according to the CCLM mode (S2304). Here, the reference line of the corresponding luma region is indicated by a reference line index of the corresponding luma region.

The video decoding device may determine the luma reference line by using one of the methods of Example 2 to Example 4, corresponding to the case where the prediction mode of the current chroma block is CCLM.

The video decoding device selects the chroma reference pixels from the chroma reference line and the luma reference pixels from the luma reference line, and generates a linear relation between the luma reference pixels and the chroma reference pixels (S2306).

The video decoding device uses the linear relation to generate a predictor of the current chroma block from the pixels in the corresponding luma region (S2308).

The video decoding device reconstructs the current chroma block by summing the predictor and the residual block (S2310).

Although the steps in the respective flowcharts are described to be sequentially performed, the steps merely instantiate the technical idea of some embodiments of the present disclosure. Therefore, a person having ordinary skill in the art to which this disclosure pertains could perform the steps by changing the sequences described in the respective drawings or by performing two or more of the steps in parallel. Hence, the steps in the respective flowcharts are not limited to the illustrated chronological sequences.

It should be understood that the above description presents illustrative embodiments that may be implemented in various other manners. The functions described in some embodiments may be realized by hardware, software, firmware, and/or their combination. It should also be understood that the functional components described in the present disclosure are labeled by “ . . . unit” to strongly emphasize the possibility of their independent realization.

Meanwhile, various methods or functions described in some embodiments may be implemented as instructions stored in a non-transitory recording medium that can be read and executed by one or more processors. The non-transitory recording medium may include, for example, various types of recording devices in which data is stored in a form readable by a computer system. For example, the non-transitory recording medium may include storage media, such as erasable programmable read-only memory (EPROM), flash drive, optical drive, magnetic hard drive, and solid state drive (SSD) among others.

Although embodiments of the present disclosure have been described for illustrative purposes, those having ordinary skill in the art to which this disclosure pertains should appreciate that various modifications, additions, and substitutions are possible, without departing from the idea and scope of the present disclosure. Therefore, embodiments of the present disclosure have been described for the sake of brevity and clarity. The scope of the technical idea of the embodiments of the present disclosure is not limited by the illustrations. Accordingly, those having ordinary skill in the art to which the present disclosure pertains should understand that the scope of the present disclosure should not be limited by the above explicitly described embodiments but by the claims and equivalents thereof.

What is claimed is:

1. A method performed by a video decoding device for intra-predicting a current chroma block, the method comprising:
decoding from a bitstream a chroma intra-prediction mode of the current chroma block;
determining, based on multiple neighboring chroma pixel lines of the current chroma block or multiple neighboring luma pixel lines of a representative luma block, a reference line of one of the multiple neighboring chroma pixel lines that corresponds to the current chroma block to provide a determined reference line, wherein the current chroma block uses a reference line that is indicated by a reference line index of the current chroma block; and
generating a predictor of the current chroma block by using the determined reference line according to the chroma intra-prediction mode.

2. The method of claim 1, further comprising:
decoding from the bitstream a cross-component linear model (CCLM) mode flag that indicates whether a CCLM mode is enabled; and
checking the CCLM mode flag,
wherein when the CCLM mode flag is false, the method further comprises:
decoding the chroma intra-prediction mode.

3. The method of claim 1, wherein determining the reference line includes:
decoding the reference line index of the current chroma block from the bitstream separately from a luma channel.

4. The method of claim 1, further comprising:
reconstructing a reference line index of the representative luma block, the reference line index of the representative luma block indicating one of the multiple neighboring luma pixel lines as a reference line of the representative luma block; and
decoding an index difference from the bitstream,
wherein determining the reference line includes:
summing the reference line index of the representative luma block and the index difference to determine the reference line index of the current chroma block.

5. The method of claim 1, further comprising:
reconstructing a reference line index of the representative luma block;
decoding from the bitstream a flag indicating that the reference line index of the representative luma block and the reference line index of the current chroma block are identical; and
checking the flag,
wherein determining the reference line includes:
when the flag is true, determining the reference line index of the current chroma block as the reference line index value of the representative luma block.

6. The method of claim 1, wherein determining the reference line includes:
determining the reference line index of the current chroma block by referring to one or more data items among information on the current chroma block.

7. The method of claim 6, wherein determining the reference line includes:
determining the reference line index based on the intra-prediction mode, a width of the current chroma block, and a height of the current chroma block among the information on the current chroma block.

8. The method of claim 1, further comprising:
reconstructing a reference line index of the representative luma block,
wherein determining the reference line comprises:
passing the reference line index of the representative luma block by inheritance to the current chroma block as the reference line index of the current chroma block.

9. The method of claim 8, wherein determining the reference line includes:
responsive to different spatial resolutions between a chroma channel and a luma channel, shifting a reference line index of the representative luma block to generate the reference line index of the current chroma block.

10. The method of claim 8, wherein determining the reference line includes:
passing the reference line index of the representative luma block by inheritance to the current chroma block as the reference line index of the current chroma block by referring to one or more data items among information on the representative luma block and information on the current chroma block.

11. The method of claim 10, further comprising:
when the representative luma block and the current chroma block have an equal aspect ratio, passing the reference line index of the representative luma block by inheritance to the current chroma block as the reference line index of the current chroma block.

12. The method of claim 10, wherein determining the reference line includes:
when the representative luma block has a reference line that is co-located with the reference line of the current chroma block, passing the reference line index of the representative luma block by inheritance to the current chroma block as the reference line index of the current chroma block, wherein the reference line of the representative luma block and the reference line of the current chroma block are determined to be co-located when the current chroma block has a corresponding luma region having a top or left boundary that partially overlaps with a top or left boundary of the representative luma block.

13. The method of claim 10, wherein determining the reference line includes:
when the representative luma block has an intra-prediction mode that is identical to an intra-prediction mode of the current chroma block and when using no adjacent reference line among the multiple reference lines of the representative luma block, passing the reference line index of the representative luma block by inheritance to the current chroma block as the reference line index of the current chroma block.

14. The method of claim 8, further comprising:
decoding from the bitstream a flag indicative of inheritance of the reference line index of the representative luma block; and
checking the flag,
wherein determining the reference line includes:
when the flag is true, passing the reference line index of the representative luma block by inheritance to the current chroma block as the reference line index of the current chroma block.

15. The method of claim 1, wherein the representative luma block comprises luma pixels corresponding to pixels at preset positions of the current chroma block.

16. A method performed by a video encoding device for intra-predicting a current chroma block, the method comprising:
determining a chroma intra-prediction mode of the current chroma block;
determining, based on multiple neighboring chroma pixel lines of the current chroma block or multiple neighboring luma pixel lines of a representative luma block, a reference line of one of the multiple neighboring chroma pixel lines that corresponds to the current chroma block to provide a determined reference line, wherein the current chroma block uses a reference line that is indicated by a reference line index of the current chroma block; and
generating a predictor of the current chroma block by using the determined reference line according to the chroma intra-prediction mode.

17. The method of claim 16, further comprising:
determining a cross-component linear model (CCLM) mode flag that indicates whether a CCLM mode is enabled; and
checking the CCLM mode flag,
wherein when the CCLM mode flag is false, the method further comprises:
determining the chroma intra-prediction mode.

18. The method of claim 16, wherein the representative luma block comprises luma pixels corresponding to pixels at preset positions of the current chroma block.

19. A non-transitory computer-readable recording medium storing a bitstream generated by a video encoding method, the video encoding method comprising:
determining a chroma intra-prediction mode of a current chroma block;
determining, based on multiple neighboring chroma pixel lines of the current chroma block or multiple neighboring luma pixel lines of a representative luma block, a reference line of one of the multiple neighboring chroma pixel lines that corresponds to the current chroma block to provide a determined reference line, wherein the current chroma block uses a reference line that is indicated by a reference line index of the current chroma block; and
generating a predictor of the current chroma block by using the determined reference line according to the chroma intra-prediction mode.

20. The non-transitory computer-readable recording medium of claim 19, wherein the representative luma block comprises luma pixels corresponding to pixels at preset positions of the current chroma block.
